(19) United States
(12) Patent Application Publication
(10) Pub. No.: US 2025/0393037 A1
(43) Pub. Date: Dec. 25, 2025

(54) COMMUNICATION METHOD, COMMUNICATION DEVICE, AND COMPUTER-READABLE STORAGE MEDIUM

(71) Applicant: HUAWEI TECHNOLOGIES CO., LTD., Shenzhen (CN)

(72) Inventors: Shan Wen, Chengdu (CN); Huang Huang, Chengdu (CN)

(73) Assignee: HUAWEI TECHNOLOGIES CO., LTD., Shenzhen (CN)

(21) Appl. No.: 19/315,664

(22) Filed: Sep. 1, 2025

Related U.S. Application Data
(63) Continuation of application No. PCT/CN2023/083202, filed on Mar. 22, 2023.

(51) Int. Cl. H04W 72/0446; H04L 5/00

(52) U.S. Cl. CPC H04W 72/0446; H04L 5/0098

(57) ABSTRACT

This application relates to a communication method, a communication device, and a computer-readable storage medium. In the method, a communication device obtains a set of data streams, where a first data stream in the set includes a set of data segments, and each data segment in the set of data segments includes a data sequence and at least one predetermined sequence. The communication device processes the set of data streams to obtain a time-domain signal including a plurality of subsymbols, where tail signals of the plurality of subsymbols are the same, and the tail signal is associated with the at least one predetermined sequence. Then, the communication device sends the time-domain signal.

### CROSS-REFERENCE TO RELATED APPLICATIONS

This application is a continuation of International Application No. PCT/CN2023/083202, filed on Mar. 22, 2023, the disclosure of which is hereby incorporated by reference in its entirety.

### TECHNICAL FIELD

This application relates to the communication field, and in particular, to a communication method, a communication device, and a computer-readable storage medium in integrated sensing and communications (ISAC).

### BACKGROUND

ISAC means sensing, when information is transmitted on a radio channel, physical features of a surrounding environment by actively recognizing and analyzing characteristics of the channel, to implement mutual enhancement of communication and sensing functions. One of key technologies of the ISAC is designing a waveform to satisfy waveform requirements of both communication and sensing signals. Currently, the design of the waveform is incomplete and needs to be further enhanced.

### SUMMARY

Embodiments of the present disclosure provide an improved communication solution, to resolve the foregoing and other potential problems.

According to a first aspect of embodiments of the present disclosure, a communication method is provided. The method includes: obtaining a set of data streams, where a first data stream in the set includes a set of data segments, and each data segment in the set of data segments includes a data sequence and at least one predetermined sequence; and processing the set of data streams to obtain a time-domain signal including a plurality of subsymbols, where tail signals of the plurality of subsymbols are the same, and the tail signal is associated with the at least one predetermined sequence; and sending the time-domain signal.

In view of this, the tail signals of the subsymbols are the same, and a tail signal of a previous subsymbol may be considered as a cyclic prefix of a next subsymbol. Therefore, when a receiver divides a received signal into a plurality of signal blocks, interference between the signal blocks is weak, and interference between subcarriers of a frequency-domain signal corresponding to the signal block is also weak. In addition, the receiver may perform Doppler estimation at a signal block granularity, so that a maximum unambiguous Doppler frequency can be maximally increased by L_{sub} times (where L_{sub} is a quantity of subsymbols). In addition, because the frequency-domain signal corresponding to the signal block has a larger subcarrier spacing, and the frequency-domain signal can cope with a larger Doppler frequency shift, the receiver may demodulate sent data at a signal block granularity, to improve data demodulation performance in a high Doppler scenario. In conclusion, in a waveform (signal) design provided in embodiments of the present disclosure, communication performance and sensing performance can be improved, especially for the high Doppler scenario. In addition, in this waveform design, a subcarrier spacing at a transmit end is not changed, and duration of a symbol including a cyclic prefix remains unchanged, and compatibility with an existing waveform (for example, NR OFDM/DFT-s-OFDM) can be implemented.

In some embodiments, lengths of the plurality of subsymbols are the same, and are determined based on a quantity that is of sampling points and that corresponds to the time-domain signal and a quantity of the plurality of subsymbols. Therefore, the receiver can divide the received signal into the plurality of signal blocks by using the lengths of the subsymbols as references.

In some embodiments, a quantity of the plurality of subsymbols may be associated with at least one of the following: a subcarrier mapping spacing associated with subcarrier mapping included in the processing; a quantity of data segments; or a quantity that is of sampling points and that corresponds to the time-domain signal. Based on this association, the quantity of the subsymbols may be determined, and the time-domain signal is divided into the plurality of subsymbols.

In some embodiments, a length of the data segment is determined based on at least one of the following: a quantity that is of subcarriers and that corresponds to bandwidth allocated for the processing; a quantity of the plurality of subsymbols; or a subcarrier mapping spacing associated with subcarrier mapping included in the processing. Therefore, the length of the data segment can be determined, and a required time-domain signal may be designed.

In some embodiments, the set may include a plurality of data streams, the plurality of data streams include the first data stream and a second data stream, and a periodic time-domain signal is obtained by performing the processing on the second data stream. A predetermined sequence is added to the data segment included in the first data stream. The predetermined sequence and a periodic characteristic of another time-domain signal cause the tail signals of the subsymbols in the time-domain signal to be the same, so that interference between the signal blocks and interference between the subcarriers of the frequency-domain signal corresponding to the signal block are reduced. In addition, in some embodiments, a plurality of frequency-domain signals corresponding to the plurality of data streams completely occupy allocated bandwidth, to implement full use of frequency band resources. In some embodiments, there may be one first data stream. In this case, a peak to average power ratio (PAPR) of a waveform can be improved.

In some embodiments, a quantity of second data streams may be associated with at least one of the following: a subcarrier mapping spacing associated with the subcarrier mapping included in the processing; or a quantity that is of sampling points and that corresponds to the time-domain signal. Therefore, a required time-domain signal can be designed.

In some embodiments, the set of data streams may include one data stream, and the data stream is the first data stream. In this case, a PAPR of a waveform can be further improved.

In some embodiments, the at least one predetermined sequence may include at least one of the following: a head sequence, where the head sequence is before the data sequence; or a tail sequence, where the tail sequence is after the data sequence. Therefore, the tail signals of the subsymbols in the time-domain signal can be the same.

In some embodiments, a first quantity of front-part sampling points of each of the subsymbols is associated with the head sequence, and a second quantity of rear-part sampling points is associated with both the head sequence and the tail sequence. Therefore, the subsymbol in the time-domain signal can be designed by designing the head sequence and the tail sequence.

In some embodiments, the first quantity is determined based on at least one of a length of the head sequence, a quantity that is of subcarriers and that corresponds to bandwidth allocated for the processing, and a quantity that is of sampling points and that corresponds to the time-domain signal; and the second quantity is determined based on at least one of a length of the tail sequence, the quantity that is of subcarriers and that corresponds to the bandwidth allocated for the processing, and the quantity that is of sampling points and that corresponds to the time-domain signal. Therefore, the subsymbol in the time-domain signal can be designed.

In some embodiments, a length of the head sequence may be associated with at least one of the following: a quantity that is of subcarriers and that corresponds to bandwidth allocated for the processing; a quantity that is of sampling points and that corresponds to the time-domain signal; a quantity of the plurality of subsymbols; and an expected mean square error level for a difference between the tail signals of the subsymbols. Therefore, the length of the head sequence can be determined.

In some embodiments, a length of the tail sequence may be associated with at least one of the following: a length of a cyclic prefix added to the time-domain signal; a quantity that is of subcarriers and that corresponds to bandwidth allocated for the processing; a quantity that is of sampling points and that corresponds to the time-domain signal; a quantity of the plurality of subsymbols; and an expected mean square error level for a difference between the tail signals of the subsymbols. Therefore, the length of the tail sequence can be determined.

In some embodiments, processing the set of data streams may include: precoding the set of data streams to obtain a set of frequency-domain streams; separately performing subcarrier mapping on a frequency-domain stream in the set of frequency-domain streams, to obtain a frequency-domain signal; and performing frequency-domain to time-domain transform on the frequency-domain signal to obtain the time-domain signal. In this manner, a to-be-sent time-domain signal can be generated.

In some embodiments, precoding the set of data streams includes at least one of the following: determining, based on one index of a data stream in the set of data streams, a method for performing preprocessing on the data stream; and determining, based on indexes of a plurality of data streams in the set of data streams, a method for precoding the plurality of data streams. In this manner, single-stream independent precoding, multi-stream joint precoding, or a combination of the two can be implemented.

In some embodiments, separately performing the subcarrier mapping on the frequency-domain stream may include: determining, based on at least one of an index of the frequency-domain stream, a signal length corresponding to the frequency-domain stream, or a subcarrier mapping spacing associated with the subcarrier mapping, a subcarrier index corresponding to the frequency-domain stream. Therefore, a to-be-used subcarrier can be determined.

In some embodiments, a subcarrier mapping spacing associated with the subcarrier mapping may be associated with at least one of the following: a quantity of data streams in the set;

a quantity of the plurality of subsymbols; a quantity that is of sampling points and that corresponds to the time-domain signal; or a quantity of the data segments. Therefore, the subcarrier mapping spacing can be determined.

In some embodiments, sending the time-domain signal includes: adding a cyclic prefix to the time-domain signal; and sending the time-domain signal to which the cyclic prefix is added. Therefore, signal sending can be completed.

According to a second aspect of embodiments of the present disclosure, a communication method is provided. The method includes: receiving a signal, where the signal includes a cyclic prefix and a plurality of subsymbols; dividing the signal into a plurality of blocks based on a length of the cyclic prefix and lengths of the plurality of subsymbols, to cause an overlap of the length of the cyclic prefix to exist between two adjacent blocks in the plurality of blocks; and performing processing based on the plurality of blocks. In this method, it can be implemented that time-domain interference between the plurality of blocks is weak, and interference between frequency-domain subcarriers of a frequency-domain signal corresponding to each block is also weak. In this way, perception and communication performance is improved.

In some embodiments, performing the processing includes removing a third quantity of front-part sampling values of each of the plurality of blocks, to obtain a plurality of processed blocks, where the third quantity corresponds to the length of the cyclic prefix; and performing the processing based on the plurality of processed blocks. Therefore, preprocessing on the received signal can be completed by performing block division based on the lengths of the subsymbols and the length of the cyclic prefix. In addition, a feature that a tail signal of a preceding subsymbol may be considered as a cyclic prefix of a next subsymbol enables low-complexity signal processing to be performed in frequency domain after the CP is removed.

In some embodiments, the signal is an echo signal from a target, and the processing is sensing processing. Therefore, performance of a sensing receiver can be improved.

In some embodiments, the signal is a signal received through a communication channel, and the processing is communication information demodulation processing. Therefore, performance of a communication receiver can be improved.

According to a third aspect of embodiments of the present disclosure, a communication apparatus is provided. The apparatus includes: an obtaining unit, configured to obtain a set of data streams, where a first data stream in the set includes a set of data segments, and each data segment in the set of data segments includes a data sequence and at least one predetermined sequence; a processing unit, configured to process the set of data streams to obtain a time-domain signal including a cyclic prefix and a plurality of subsymbols, where tail signals of the plurality of subsymbols are the same, and the tail signal is associated with the at least one predetermined sequence; and a sending unit, configured to send the time-domain signal.

In some embodiments, lengths of the plurality of subsymbols are the same, and are determined based on a quantity that is of sampling points and that corresponds to the time-domain signal and a quantity of the plurality of subsymbols.

In some embodiments, a quantity of the plurality of subsymbols may be associated with at least one of the following: a subcarrier mapping spacing associated with subcarrier mapping included in the processing; a quantity of data segments; or a quantity that is of sampling points and that corresponds to the time-domain signal. Based on this association, the quantity of the subsymbols may be determined, and the time-domain signal is divided into the plurality of subsymbols. In some embodiments, a length of the data segment is determined based on at least one of the following: a quantity that is of subcarriers and that corresponds to bandwidth allocated for the processing; a quantity of the plurality of subsymbols; or a subcarrier mapping spacing associated with subcarrier mapping included in the processing.

In some embodiments, the set of data streams may include a plurality of data streams, the plurality of data streams include the first data stream and a second data stream, and a periodic time-domain signal is obtained by performing the processing on the second data stream. In some embodiments, a periodicity of the periodic time-domain signal may be related to a length of each of the plurality of subsymbols.

In some embodiments, a quantity of second data streams may be associated with at least one of the following: a subcarrier mapping spacing associated with the subcarrier mapping included in the processing; or a quantity that is of sampling points and that corresponds to the time-domain signal.

In some embodiments, the set may include one data stream, and the data stream is the first data stream.

In some embodiments, the at least one predetermined sequence may include at least one of the following: a head sequence, where the head sequence is before the data sequence; or a tail sequence, where the tail sequence is after the data sequence. In some embodiments, a first quantity of front-part sampling points of each of the subsymbols is associated with the head sequence, and a second quantity of rear-part sampling points is associated with both the head sequence and the tail sequence.

In some embodiments, the first quantity is determined based on at least one of a length of the head sequence, a quantity that is of subcarriers and that corresponds to bandwidth allocated for the processing, and a quantity that is of sampling points and that corresponds to the time-domain signal; and the second quantity is determined based on at least one of a length of the tail sequence, the quantity that is of subcarriers and that corresponds to the bandwidth allocated for the processing, and the quantity that is of sampling points and that corresponds to the time-domain signal.

In some embodiments, a length of the head sequence may be associated with at least one of the following: a quantity that is of subcarriers and that corresponds to bandwidth allocated for the processing; a quantity that is of sampling points and that corresponds to the time-domain signal; a quantity of the plurality of subsymbols; and an expected mean square error level for a difference between the tail signals of the subsymbols.

In some embodiments, a length of the tail sequence may be associated with at least one of the following: a length of a cyclic prefix added to the time-domain signal; a quantity that is of subcarriers and that corresponds to bandwidth allocated for the processing; a quantity that is of sampling points and that corresponds to the time-domain signal; a quantity of the plurality of subsymbols; and an expected mean square error level for a difference between the tail signals of the subsymbols.

In some embodiments, the processing unit may include: a precoding unit, configured to precode the set of data streams to obtain a set of frequency-domain streams; a subcarrier mapping unit, configured to separately perform subcarrier mapping on a frequency-domain stream in the set of frequency-domain streams, to obtain a frequency-domain signal; a transform unit, configured to perform frequency-domain to time-domain transform on the frequency-domain signal to obtain a transformed signal; and an adding unit, configured to add a cyclic prefix to the converted signal to obtain the time-domain signal. In some embodiments, the precoding unit includes at least one of the following: a first determining unit, configured to determine, based on an index of one data stream in the set of data streams, a method for precoding the data stream; and a second determining unit, configured to determine, based on indexes of a plurality of data streams in the set of data streams, a method for precoding the plurality of data streams.

In some embodiments, the subcarrier mapping unit may include: a determining unit, configured to determine, based on at least one of an index of the frequency-domain stream, a signal length corresponding to the frequency-domain stream, a subcarrier mapping spacing associated with the subcarrier mapping, or a quantity that is of subcarriers and that corresponds to bandwidth allocated for the processing, a subcarrier index corresponding to the frequency-domain stream.

In some embodiments, a subcarrier mapping spacing associated with the subcarrier mapping may be associated with at least one of the following: a quantity of data streams in the set; a quantity of the plurality of subsymbols; or a quantity that is of sampling points and that corresponds to the time-domain signal.

In some embodiments, the sending unit includes: an adding unit, configured to add a cyclic prefix to the time-domain signal; and a signal sending unit, configured to send the time-domain signal to which the cyclic prefix is added.

According to a fourth aspect of embodiments of the present disclosure, a communication apparatus is provided. The apparatus includes: a receiving unit, configured to receive a signal, where the signal includes a cyclic prefix and a plurality of subsymbols; a block division unit, configured to divide the signal into a plurality of blocks based on a length of the cyclic prefix and lengths of the plurality of subsymbols, to cause an overlap of the length of the cyclic prefix to exist between two adjacent blocks in the plurality of blocks; and a processing unit, configured to perform processing based on the plurality of blocks.

In some embodiments, the processing unit may include: a removing unit, configured to remove a third quantity of front-part sampling values of each of the plurality of blocks, to obtain a plurality of processed blocks, where the third quantity corresponds to the length of the cyclic prefix; and an execution unit, configured to perform the processing based on the plurality of processed blocks.

In some embodiments, the signal is an echo signal from a target, and the processing is sensing processing. In some embodiments, the signal is a signal received through a communication channel, and the processing is communication information demodulation processing.

According to a fifth aspect of embodiments of the present disclosure, a communication device is provided. The device includes: a processor; and a memory including computer program code, where when the computer program code is run by the processor, the method according to the first aspect or the second aspect is performed.

According to a sixth aspect of embodiments of the present disclosure, a computer-readable storage medium is provided. The computer-readable storage medium includes machine-executable instructions, where when the machine-executable instructions are executed by a device, the method according to the first aspect or the second aspect is performed.

According to a seventh aspect of embodiments of the present disclosure, a chip is provided, including a memory and a processor, where the memory is configured to store a computer program, and the processor is configured to invoke the computer program from the memory and run the computer program, to perform the method in the first aspect or the second aspect.

According to an eighth aspect of embodiments of the present disclosure, a computer program product is provided. The computer program product includes computer program code, and when the computer program code is executed by a device, the method in the first aspect or the second aspect is performed.

It is to be understood from the following descriptions of the example embodiments that, according to the technical solution provided herein, interference in a sub-block and interference between sub-blocks when an echo signal is divided into blocks can be reduced, and accuracy of a sensing signal can be improved.

It should be understood that the content described in the summary is not intended to limit key or important features of embodiments of the present disclosure, nor is it intended to limit the scope of the present disclosure. Other features of the present disclosure are to be readily understood through the following description.

### BRIEF DESCRIPTION OF DRAWINGS

With reference to the accompanying drawings and the following detailed descriptions, the foregoing and other features, advantages, and aspects of embodiments of the present disclosure become more apparent. In the accompanying drawings, same or similar reference numerals indicate same or similar elements.

FIG. 1 is a diagram of an example communication network in which embodiments of the present disclosure may be implemented;

FIG. 2 is a diagram of a symbol of a time-domain signal and a corresponding echo signal according to a conventional solution;

FIG. 3 is a schematic flowchart of a sending method according to an embodiment of the present disclosure;

FIG. 4A is a diagram of a symbol of a time-domain signal according to an embodiment of the present disclosure;

FIG. 4B is a diagram of example signal amplitude according to an embodiment of the present disclosure;

FIG. 5A is a diagram of a generation process of a waveform according to an embodiment of the present disclosure;

FIG. 5B is a diagram of another generation process of a waveform according to an embodiment of the present disclosure;

FIG. 5C is a diagram of a generation process of a 1^{st} frequency-domain signal to an (L−1)^{th} frequency-domain signal according to an embodiment of the present disclosure;

FIG. 6A is a diagram of an envelope of an example signal according to an embodiment of the present disclosure;

FIG. 6B is a diagram of an MSE simulation result according to an embodiment of the present disclosure;

FIG. 6C is a diagram of a superposed envelope of three example signals through joint precoding according to an embodiment of the present disclosure;

FIG. 7A is a diagram of another generation process of a waveform according to an embodiment of the present disclosure;

FIG. 7B is a diagram of a generation process of a 1^{st} frequency-domain signal according to an embodiment of the present disclosure;

FIG. 8 is a diagram of another generation process of a waveform according to an embodiment of the present disclosure;

FIG. 9 is a curve diagram of PAPR comparison of waveforms for a solution according to an embodiment of the present disclosure;

FIG. 10 is a diagram of a processing process of a transmitted signal according to an embodiment of the present disclosure;

FIG. 11 is a schematic flowchart of a receiving method according to an embodiment of the present disclosure;

FIG. 12A is a diagram of a processing process of an echo signal according to an embodiment of the present disclosure;

FIG. 12B is a diagram of a processing process of a communication signal according to an embodiment of the present disclosure;

FIG. 13 is a block diagram of a communication apparatus according to an embodiment of the present disclosure;

FIG. 14 is a block diagram of another communication apparatus according to an embodiment of the present disclosure; and

FIG. 15 is a simplified block diagram of a communication device suitable for implementing embodiments of the present disclosure.

### DESCRIPTION OF EMBODIMENTS

Embodiments of the present disclosure are described in more detail in the following with reference to the accompanying drawings. Although some embodiments of the present disclosure are shown in the accompanying drawings, it should be understood that the present disclosure can be implemented in various forms, and should not be construed as being limited to embodiments described herein, and instead, these embodiments are provided for a more thorough and complete understanding of the present disclosure. It should be understood that the accompanying drawings and embodiments of the present disclosure are merely used as examples and are not intended to limit the protection scope of the present disclosure.

The term “include” and variants thereof used herein indicate open inclusion, that is, “include but is not limited to”. The term “based on” indicates “at least partly based on”. The term “one embodiment” indicates “at least one embodiment”. The term “another embodiment” indicates “at least one another embodiment”. Definitions of other terms are provided in the following description.

It should be understood that although the terms “first” and “second” may be used herein to describe various elements, these elements should not be limited by these terms. These terms are only used to distinguish one element from another. For example, a first element may be referred to as a second element, and similarly the second element may be referred to as the first element without departing from the scope of the embodiments. The term “and/or” used in this specification includes any and all combinations of one or more of the listed terms.

The term “circuit” used herein refers to one or more of the following:
(a) hardware circuit implementation only (such as implementations of analog and/or digital circuits only);
(b) a combination of hardware circuit and software, for example (if applicable): (i) a combination of analog and/or digital hardware circuits and software/firmware, and (ii) any part of a hardware processor and software (including a digital signal processor, software, and a memory that work together to enable an apparatus like an optical line terminal (OLT) or another computing device to perform various functions); and
(c) a hardware circuit and/or a processor, such as a microprocessor or a part of a microprocessor, which requires software (such as firmware) for operation, but may not have software when software is not required for operation.

The definition of a circuit is applicable to all scenarios of use of the term in this application (including any claim). As another example, the term “circuit” used herein also covers implementations of only a hardware circuit or a processor (or a plurality of processors), a part of a hardware circuit or a processor, or software or firmware accompanying a hardware circuit or a processor. For example, if applicable to a particular claim element, the term “circuit” further covers a baseband integrated circuit, a processor integrated circuit, an OLT, or a similar integrated circuit in another computing device.

As used in this specification, the term “terminal device” is any device that has a wireless or wired communication capability. An example of the terminal device includes but is limited to customer premise equipment (CPE), user equipment (UE), a personal computer, a desktop computer, a mobile phone, a cellular phone, a smartphone, a personal digital assistant (PDA), a portable computer, a tablet, a wearable device, an internet of things (IoT) device, a machine type communication (MTC) device, a vehicle-mounted device used for vehicle-to-everything (V2X) (X refers to a pedestrian, a vehicle, or an infrastructure/network) communication, an image capture device like a digital camera, a game device, a music storage and playback device, or an internet device capable of wireless or wired internet access and browsing.

In addition, the term “network device” is a device that can provide or host a cell or coverage in which a terminal device may perform communication. An example of the network device includes but is not limited to a NodeB (NodeB or NB), an evolved NodeB (eNodeB or eNB), a next generation NodeB (gNB), a transmission reception point (TRP), a remote radio unit (RRU), a radio head (RH), a remote radio head (RRH), or a low power node like a femto node or a pico node. Considering rapid development of communication technologies, future types of communication networks and communication protocols may emerge, and the present disclosure may be combined with the future types of communication networks and communication protocols. The scope of the present disclosure should not be considered as being limited only to the foregoing communication networks and communication protocols.

As mentioned above, one of key technologies of ISAC is using a waveform design to satisfy waveform requirements of both communication and sensing signals. Reducing deployment costs of sensing hardware with the help of widely deployed cellular networks, and achieving ISAC functions by using an existing and appropriately modified communication waveform are a promising choice. A discrete Fourier transform-spread-orthogonal frequency division multiplexing (DFT-s-OFDM) waveform and a cyclic prefix-orthogonal frequency division multiplexing (CP-OFDM) waveform that have advantages such as high spectral efficiency and can be for resisting inter-symbol interference are wildly used in long term evolution (LTE) and new radio (NR). To resolve a problem that a Doppler frequency shift of an orthogonal frequency division multiplexing (OFDM) waveform in a high-speed movement scenario is high, an orthogonal time frequency space (OTFS) waveform becomes a research hotspot, because modulated symbol information of the OTFS waveform in delay-Doppler domain can obtain full diversity gains in both time domain and frequency domain.

Embodiments of the present disclosure provides a waveform processing solution. Modulated data (that is, a waveform) is processed, to obtain a time-domain signal including a cyclic prefix and a plurality of subsymbols. Tail signals of the subsymbols are the same. In this manner, a tail signal of a preceding subsymbol may be considered as a cyclic prefix of a next subsymbol. Therefore, when a receiver divides a received signal into a plurality of signal blocks, interference between the signal blocks is weak, and interference between subcarriers of a frequency-domain signal corresponding to the signal block is also weak. In addition, the receiver may perform Doppler estimation at a signal block granularity, so that a maximum unambiguous Doppler frequency can be maximally increased by L_{sub} times (where L_{sub} is a quantity of subsymbols). In addition, because the frequency-domain signal corresponding to the signal block has a larger subcarrier spacing, and the frequency-domain signal can cope with a larger Doppler frequency shift, the receiver may demodulate sent data at a signal block granularity, to improve data demodulation performance in a high Doppler scenario. In conclusion, in a waveform (signal) design provided in the present disclosure, communication performance and sensing performance can be improved, especially for the high Doppler scenario. In addition, in this waveform design, a subcarrier spacing at a transmit end is not changed, and duration of a symbol including a cyclic prefix remains unchanged, and compatibility with an existing waveform (for example, NR OFDM/DFT-s-OFDM) can be implemented.

It is to be understood that the waveform processing solution of the present disclosure is applicable to existing CP-DFT-s-OFDM, CP-OFDM, and CP-OTFS waveforms and any appropriate waveform developed in the future. For ease of understanding, the following describes this solution in detail with reference to the accompanying drawings.

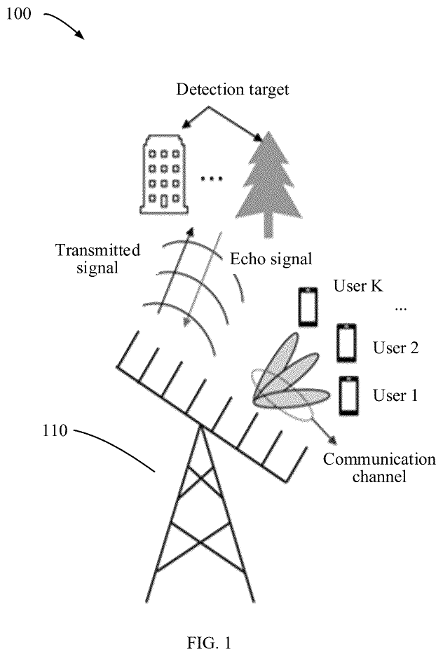

FIG. 1 is a diagram of an example communication network 100 in which embodiments of the present disclosure may be implemented. As shown in FIG. 1, the network 100 may include a communication device 110 having a communication function and a sensing function. In one aspect, the communication device 110 may send a transmitted signal to surroundings, and receive an echo signal reflected by a detection target (also referred to as a target in this specification). In another aspect, the communication device 110 may communicate with another communication device (for example, a device of a user 1, a user 2, . . . , or a user K) through a communication channel.

In some embodiments, the communication device 110 may sense surrounding environment information, such as a distance from a building to the communication device 110, a speed of a moving target like a low-altitude uncrewed aerial vehicle or a car, by measuring a difference between the transmitted signal and the echo signal, like a delay, a Doppler frequency shift, or any other appropriate information. The communication device 110 may use the sensed surrounding environment information to assist in designing or optimizing a communication link between the communication device 110 and another communication device, for example, avoiding some obstacles, to improve performance of the communication link.

Although the communication device 110 is shown herein as a network device, it should be understood that this is merely an example and the communication device 110 may be in any other appropriate form. For example, the communication device 110 may be a terminal device. Alternatively, the communication device 110 may be a chip/module including a communication function, for example, a system on a chip (SoC), or may be a dedicated chip/module, for example, a baseband chip. In general, embodiments of the present disclosure are applicable to single-user uplink or downlink transmission and multi-user uplink or downlink transmission, and also applicable to device-to-device (D2D) transmission. This is not particularly limited in the present disclosure.

The communication network 100 or the communication device 110 may comply with any appropriate standard, including but not limited to a global system for mobile communications (GSM), long term evolution (LTE), LTE-advanced (LTE-A), wideband code division multiple access (WCDMA), code division multiple access (CDMA), or a GSM/EDGE radio access network (GERAN). In addition, the communication network 100 or the communication device 110 may perform communication according to communication protocols of any generation of standard to be developed in the future, for example, a sixth generation (6G) communication protocol. An example of the communication protocol includes but is not limited to a first generation (1G), second generation (2G), 2.5G, 2.75G, third generation (3G), fourth generation (4G), 4.5G, fifth generation (5G), or sixth generation communication protocol.

It should be understood that a quantity of devices in FIG. 1 is provided for the purpose of description, and do not imply any limitation to the present disclosure. The communication network 100 may include any appropriate quantity of communication devices suitable for implementing the present disclosure. In addition, the communication network 100 may include more additional components that are not shown, or some components that are shown may be omitted. This is not limited in embodiments of the present disclosure. An implementation of the communication network 100 is also not limited to the specific examples described above, but may be implemented in any appropriate manner.

In some conventional solutions, the transmitted signal is a signal frame including a plurality of CP-DFT-s-OFDM, CP-OFDM, or CP-OTFS symbols. A sensing receiver divides the echo signal into a plurality of blocks at a granularity of a length of a symbol. After a cyclic prefix (CP) is removed, the plurality of blocks are used as inputs of a two-dimensional-discrete-Fourier-transform (2D-DFT)-based range-Doppler estimation algorithm, to obtain a delay estimate and a Doppler estimate corresponding to a sensing target.

With reference to a 2D-DFT-based rang e-Doppler estimation algorithm framework, to improve estimation performance, a solution for dividing an echo signal into blocks based on a new granularity, and a matching transmitted signal design are provided. In some solutions, dividing an echo signal frame into blocks at a granularity of a length less than a length of one symbol (for example, 0.7 times the length of the symbol), and constructing a virtual CP are proposed, to improve a maximum unambiguous range and a maximum unambiguous Doppler frequency.

However, during the division of the echo signal and construction of the virtual CP, inter-symbol interference is introduced between data in the blocks in time domain, and for a single block, inter-subcarrier interference is introduced in frequency domain.

In some solutions, a subcarrier spacing is increased to reduce duration of the CP-OFDM symbol, to improve the maximum unambiguous Doppler frequency. However, in this case, the maximum unambiguous range is significantly reduced. Moreover, in a multi-user scenario, interference may occur between subbands using different subcarrier spacings.

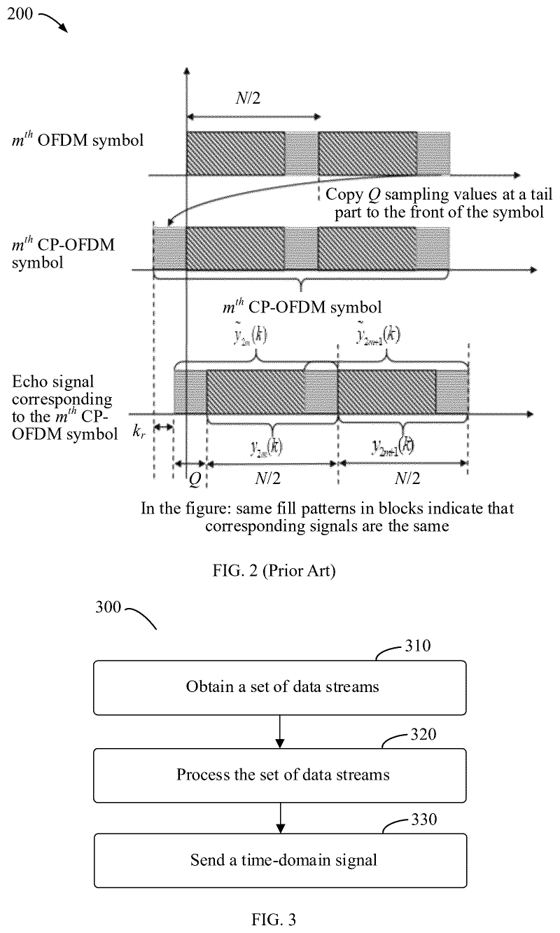

In some other solutions, a subcarrier spacing is not changed, but distributed mapping is used in frequency domain when a transmitted signal is generated, for example, one piece of data is placed at every other (G−1) subcarriers. In this solution, a sampling point of an OFDM symbol is periodic, and a periodicity is N_{sub}=N/G, where N is a quantity of sampling points of one OFDM symbol, and G is a positive integer. FIG. 2 shows timing changes of an m^{th} transmit OFDM symbol, an m^{th} transmit CP-OFDM symbol, and an echo symbol of the m^{th} transmit CP-OFDM symbol. It is assumed that a signal frame including N_{sym} CP-OFDM symbols is transmitted, and each CP-OFDM symbol includes N+Q sampling points. In this solution, an echo signal y(p) including N_{sym}(N+Q) sampling values is divided into GN_{sym} blocks [symbol] (k) at a granularity of N_{sub}+Q, where p=0, 1, . . . , N_{sym}(N+Q)−1; [symbol] =0, 1, . . . , GN_{sym}−1; and k=0, 1, . . . , N_{sub}+Q−1. There is an overlap of Q sampling values between a remaining block other than N_{sym} blocks: mG^{th}, where m=0, 1, . . . , N_{sym}−1 blocks and a preceding block of the remaining block. [symbol] (κ) may be obtained by removing first Q sampling values (that is, a CP) of each block, where [symbol] =0, 1, . . . , GN_{sym}−1; and κ=0, 1, . . . , N_{sub}−1. In this way, preprocessing on the echo signal is completed, and a preprocessed signal is used as an input of the 2D-DFT-based range-Doppler estimation algorithm for sensing processing. Due to a periodic characteristic of a transmit time-domain signal, it can be learned that the first Q sampling values at a head part of the block [symbol] (k) form the CP. After the CP is removed, there is no inter-symbol interference between data in the block in time domain, no inter-subcarrier interference in frequency domain, and no mutual interference between blocks. In this solution, a maximum unambiguous Doppler frequency can be increased by G times, but frequency utilization is low. It is assumed that allocated bandwidth corresponds to N_{sc} subcarriers. In this solution, only N_{sc}/G subcarriers are used for data transmission.

In view of this, embodiments of the present disclosure provide a design solution for a transmitted signal (that is, a sending process) and a preprocessing solution for a received signal (that is, a process of receiving divided blocks), to resolve the foregoing and other potential problems. The following provides more detailed descriptions with reference to FIG. 3 to FIG. 12. FIG. 3 is a schematic flowchart of a sending method 300 according to an embodiment of the present disclosure. The method 300 may be implemented at a sending device (for example, the communication device 110 in FIG. 1), for example, may be implemented in an integrated circuit (IC) of the sending device. For convenience, FIG. 3 is described herein with reference to the example in FIG. 1. It should be understood that the method 300 in FIG. 3 may include other additional steps that are not shown, or some shown steps may be omitted. The scope of the present disclosure is not limited thereto.

As shown in FIG. 3, at block 310, the communication device 110 may obtain a set of data streams. At least one data stream (also referred to as a first data stream in this specification for convenience) in the set may include a set of data segments (that is, one or more data segments). Each data segment may include a data sequence and at least one predetermined sequence. In other words, a quantity of first data streams may be greater than or equal to 1. A quantity of data segments may be greater than or equal to 1.

In some embodiments, the at least one predetermined sequence may include a head sequence before the data sequence. In some embodiments, the at least one predetermined sequence may include a tail sequence after the data sequence. In some embodiments, the at least one predetermined sequence may include both the head sequence before the data sequence and the tail sequence after the data sequence. In this manner, a periodic sequence can be constructed, to improve spectral efficiency and subcarrier utilization.

In some embodiments, a length of the data segment may be determined based on at least one of the following: a quantity that is of subcarriers and that corresponds to bandwidth allocated for processing; a quantity of a plurality of subsymbols; or a subcarrier mapping spacing for subcarrier mapping.

In some embodiments, the quantity of the plurality of subsymbols may be associated with at least one of the following: a subcarrier mapping spacing associated with subcarrier mapping included in processing; the quantity (donated as K) of data segments; or a quantity (donated as N) that is of sampling points and that corresponds to a time-domain signal. In some embodiments, the quantity of the plurality of subsymbols may be K*G. Both G and K are positive integers, and N_{d} can be exactly divided by K, where G*K≥2.

In some embodiments, if N can be exactly divided by G*K, a symbol x may be divided into G*K subsymbols whose lengths are all N_{sub}=N/G/K, and tail signals (including N₀ sampling values) of the subsymbols are approximately the same.

In some embodiments, if N cannot be exactly divided by G*K, cannot be exactly divided by K, but can be exactly divided by G, a symbol x may be divided into G subsymbols whose lengths are all N_{sub}=N/G, and tail signals (including N₀ sampling values) of the subsymbols are approximately the same.

In some embodiments, if N cannot be exactly divided by G*K, cannot be exactly divided by G, but can be exactly divided by K, a symbol x may be divided into K subsymbols whose lengths are all N_{sub}=N/K, and tail signals (including N₀ sampling values) of the subsymbols are approximately the same.

At block 320, the communication device 110 may process the set of data streams to obtain a time-domain signal including a plurality of subsymbols. Tail signals of the plurality of subsymbols are the same. In some embodiments, lengths of the plurality of subsymbols may be the same, and may be determined based on a quantity that is of sampling points and that corresponds to the time-domain signal and a quantity of the plurality of subsymbols. For example, at a transmit end, a symbol that includes N sampling points in time domain may be divided into L_{sub} subsymbols whose lengths are all N_{sub}=N/L_{sub}, and tail signals of the subsymbols are the same. It is assumed that the tail signal includes N₀ sampling values, and N₀ is not shorter than a length of a CP. It is clear that N₀ may alternatively be less than the length of the CP. This is not limited in this embodiment of the present disclosure.

In contexts of the present disclosure, that “the tail signals are the same” means that the tail signals are approximately the same or completely the same. “Approximately the same” means that a mean square error (MSE) level between the tail signals is less than or equal to a predetermined threshold level. “Completely the same” means that an MSE between the tail signals is equal to zero. For example, the MSE may be described as Formula (1):

$$M S E = \frac{1}{{N}_{0}} {\sum }_{{k}_{1} = {N}_{sub} - {N}_{0}}^{{N}_{sub} - 1} {\vert {{x}_{sub , ℓ}}_{1} ( {k}_{1} ) - {{x}_{sub , ℓ}}_{2} ( {k}_{1} ) \vert}^{2} , \qquad ( 1 )$$

where [symbol]
(k₁) and [symbol] (k₁) respectively represent a k₁^{th} element of an [symbol] ₁^{th} subsymbol and a k₁^{th} element of an [symbol] ₂^{th} subsymbol, 0≤ [symbol] ₁, [symbol] ₂≤L_{sub}−1, 0≤k₁≤N_{sub}−1, L_{sub} is the quantity of the subsymbols, and N_{sub} is the length of the subsymbol.

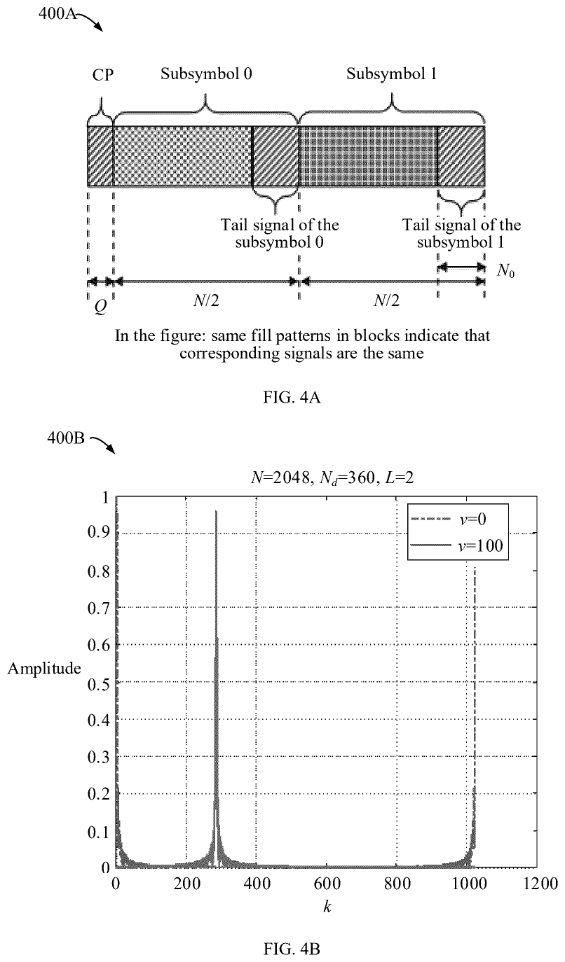

FIG. 4A is a diagram of a symbol 400A of a time-domain signal according to an embodiment of the present disclosure. In an example of FIG. 4A, L_{sub} is 2 and an MSE is 0. It can be learned that the symbol 400A includes a CP whose length is Q, a subsymbol 0, and a subsymbol 1. The symbol 400A has N+Q sampling points. Lengths of the subsymbol 0 and the subsymbol 1 are both N/2, and the subsymbol 0 and the subsymbol 1 each have a tail signal with a length of N₀ sampling points. Main parts 401 and 402 of the subsymbol 0 and the subsymbol 1 are different, but the tail signals are the same.

In contrast, in the conventional solution shown in FIG. 2, subsymbols in the m^{th} CP-OFDM symbol are completely the same. In comparison with the solution in FIG. 2, a solution in this embodiment of the present disclosure has higher spectral efficiency. In addition, in comparison with the conventional solution of increasing a subcarrier spacing, in the solution in this embodiment of the present disclosure, the subcarrier spacing may not be changed. In addition, there is no need to sacrifice a maximum unambiguous range. In comparison with the conventional solution of adjusting a quantity of sampling values of each block of an echo signal, a quantity of sampling values overlapped between adjacent blocks, and a quantity of overlapped sampling values used for constructing a virtual CP, in the solution in this embodiment of the present disclosure, significant interference between blocks and significant interference in the block when the echo signal is divided into blocks can be avoided.

According to this embodiment of the present disclosure, the tail signal may be associated with the at least one predetermined sequence. In some embodiments, the tail signal may be associated with the head sequence. In some embodiments, the tail signal may be associated with the tail sequence. In some embodiments, the tail signal may be associated with both the head sequence and the tail sequence.

According to this embodiment of the present disclosure, a same head sequence and a same tail sequence are added to data streams (for example, s₁, . . . , and s_{L-1}) in the set of data streams, so that the tail signals of the subsymbols can be approximately the same. For example, it is assumed that x₁, . . . , and x_{L-1} are all DFT-s-OFDM signals, and an l^{th} subsymbol is denoted as x_{sub,l}, where l=0, . . . , L_{sub}−1. A k₁^{th} sampling point of x_{sub,l} is denoted as x_{sub,l}[k₁], where k₁=0, 1, . . . , N_{sub}−1, and is represented by Formula (1a):

$${x}_{sub , l} [ {k}_{1} ] = x [ {lN}_{sub} + {k}_{1} ] = {\sum }_{u = 0}^{L - 1} {x}_{u} [ {lN}_{sub} + {k}_{1} ] = {x}_{0} [ {lN}_{sub} + {k}_{1} ] + {\sum }_{u = 1}^{L - 1} {x}_{u} [ {lN}_{sub} + {k}_{1} ] = {x}_{0} [ {k}_{1} ] + {\sum }_{u = 1}^{L - 1} {x}_{u} [ {lN}_{sub} + {k}_{1} ] , \qquad ( 1 a )$$

where
xᵤ[k] is a k^{th} sampling point of xᵤ, where k=0, 1, . . . , N−1. Note that x₀ is a periodic signal, and x₀[lN_{sub}+k₁]=x₀[k₁].

That the tail signals of the subsymbols are approximately the same means that when N_{sub}−N₀≤k₁≤N_{sub}−1, the following Formula (1b) is satisfied:

$${x}_{sub , 0} [ {k}_{1} ] \approx {x}_{sub , 1} [ {k}_{1} ] \approx … \approx {x}_{sub , {L}_{sub} - 1} [ {k}_{1} ] \qquad ( 1 b )$$

With reference to the foregoing Formula (1a) of x_{sub,l}[k₁], causing the tail signals to be approximately the same is equivalent to proving the following Formula (1c):

$${\sum }_{u = 1}^{L - 1} {x}_{u} [ {k}_{1} ] \approx {\sum }_{u = 1}^{L - 1} {x}_{u} [ {N}_{sub} + {k}_{1} ] \approx … \approx {\sum }_{u = 1}^{L - 1} {x}_{u} [ ( {L}_{sub} - 1 ) {N}_{sub} + {k}_{1} ] \qquad ( 1 c )$$

An expression of a signal xᵤ[k] is the following Formula (1d):

$${x}_{u} [ k ] = {e}^{j \frac{2 π ku}{N}} {\underbrace{{\sum }_{v = 0}^{{N}_{d} - 1} {s}_{u} [ v ] {g}_{rect , rect , {N}_{sub}} ( {〈 k - \frac{{vN}_{sub}}{{N}_{d}} 〉}_{{N}_{sub}} )}}_{= {\tilde{x}}_{u} [ k ]} , \qquad ( 1 d )$$

where
sᵤ[v] is a v^{th} piece of data of sᵤ, v=0, 1, . . . , N_{d}−1, and

$${g}_{rect , rect , {N}_{sub}} ( k ) = \frac{1}{{N}_{d}} {\sum }_{v = 0}^{{N}_{d} - 1} {e}^{j \frac{2 π vk}{{N}_{sub}}} .$$

With reference to definitions of g_{rect,rect,N}_{_{sub}}(k), it can be learned that g_{rect,rect,N}_{_{sub}}(k) is a function whose periodicity is N_{sub}. \tilde{x}ᵤ[k] is a signal whose periodicity is also N_{sub}. Therefore, \tilde{x}ᵤ[lN_{sub}+k₁]=\tilde{x}ᵤ[k₁]. In this way, the following Formula (1e) holds:

$${x}_{u} [ {lN}_{sub} + {k}_{1} ] = {e}^{j \frac{2 π ( {lN}_{sub} + {k}_{1} ) u}{N}} {\tilde{x}}_{u} [ {lN}_{sub} + {k}_{1} ] = {e}^{j \frac{2 π ( {lN}_{sub} + {k}_{1} ) u}{N}} {\tilde{x}}_{u} [ {k}_{1} ] \qquad ( 1 e )$$

FIG. 4B is a diagram 400B of example signal amplitude according to an embodiment of the present disclosure. In this example, it is assumed that N_{d}=360, N=2048, L=2, N_{sub}=1024, and v=0 or 100. FIG. 4B shows amplitude of

$${g}_{rect , rect , {N}_{sub}} ( {〈 k - \frac{{vN}_{sub}}{{N}_{d}} 〉}_{{N}_{sub}} )$$

in a periodicity, where k is a sampling point index. It can be learned that g_{rect,rect,N}_{_{sub}}(k) is approximately an impulse function. In view of this, based on a periodic characteristic of g_{rect,rect,N}_{_{sub}}(k), it can be found that when N_{sub}−N₀≤k₁≤N_{sub}−1, \tilde{x}ᵤ[k₁] is mainly determined by a head sequence and a tail sequence of sᵤ. In this embodiment, a same head sequence and a same tail sequence are applied to s₁, . . . , and s_{L-1}, so that \tilde{x}₁[k₁], \tilde{x}₂[k₁], . . . , and x_{L-1}[k₁] are approximately equal when N_{sub}−N₀≤k₁≤N_{sub}−1.

It is assumed that a design of the head sequence and the tail sequence causes signal energy of \tilde{x}ᵤ[k₁] is low when N_{sub}−N₀≤k₁≤N_{sub}−1. In an ideal case, when N_{sub}−N₀≤k₁≤N_{sub}−1, \tilde{x}ᵤ[k₁]=0, and the following Formula (1f) is satisfied:

$${x}_{u} [ {lN}_{sub} + {k}_{1} ] = {e}^{j \frac{2 π ( {lN}_{sub} + {k}_{1} ) u}{N}} {\tilde{x}}_{u} [ {k}_{1} ] = 0 = {e}^{j \frac{2 π {k}_{1} u}{N}} {\tilde{x}}_{u} [ {k}_{1} ] = {x}_{u} [ {k}_{1} ] \qquad ( 1 f )$$

In this case, the following Formula (1g) holds:

$${\sum }_{u = 1}^{L - 1} {x}_{u} [ {k}_{1} ] \approx {\sum }_{u = 1}^{L - 1} {x}_{u} [ {N}_{sub} + {k}_{1} ] \approx … \approx {\sum }_{u = 1}^{L - 1} {x}_{u} [ ( {L}_{sub} - 1 ) {N}_{sub} + {k}_{1} ] \qquad ( 1 g )$$

In conclusion, the same head sequence and the same tail sequence are added to s₁, . . . , and s_{L-1}, and the periodic signal x₀ whose periodicity is N_{sub} is designed, so that the tail signals of the subsymbols can be approximately the same.

In some embodiments, the set of data streams may include a plurality of data streams. The plurality of data streams include: the foregoing first data stream including the set of data segments; and at least one data stream that is processed to obtain a periodic time-domain signal (also referred to as a second data stream in this specification for convenience). In some embodiments, a periodicity of the periodic time-domain signal is related to the length of each of the plurality of subsymbols. In some embodiments, the second data stream includes only a data sequence, and does not include the foregoing at least one predetermined sequence.

In this embodiment of the present disclosure, a quantity (donated as U) of second data streams may be greater than or equal to 1. In some embodiments, the quantity of second data streams is associated with at least one of the following: a subcarrier mapping spacing associated with subcarrier mapping included in the processing; or a quantity (donated as N) that is of sampling points and that corresponds to the time-domain signal. It is assumed that mapping is performed, at a spacing of G−1 subcarriers, on a frequency stream corresponding to a data stream, where G is a positive integer greater than or equal to a quantity of data streams. In some embodiments, U may be an integer less than the quantity of data streams in the set of data streams. In some embodiments, U may be equal to 1. In some embodiments, U may be a positive integer that can be exactly divided by G. In some embodiments, U may be a common divisor of G and N. It should be understood that any other appropriate manner is also feasible.

In an embodiment, the set of data streams includes: a plurality of first data streams each including a data segment; and one or more second data streams. It is assumed that the set includes L data streams, and L is an integer greater than or equal to 2. A 2^{nd} stream to an 1^{th} stream correspond to the plurality of first data streams. In some embodiments, considering an uplink scenario, the L data streams may be from a plurality of users. In some embodiments, considering an uplink scenario, the L data streams may alternatively be from one user. In some embodiments, considering a downlink scenario, the L data streams may alternatively be data sent by a base station to a plurality of users. In some embodiments, considering a downlink scenario, the L data streams may alternatively be data sent by a base station to one user.

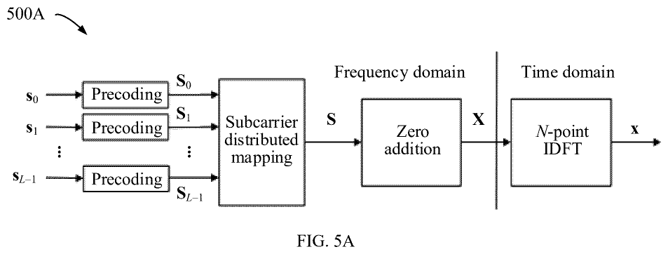

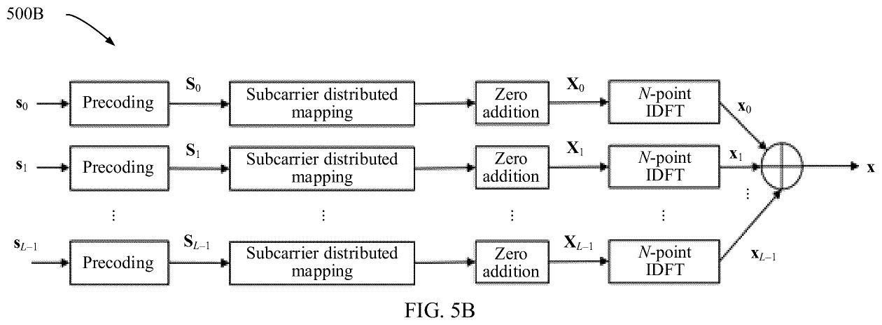

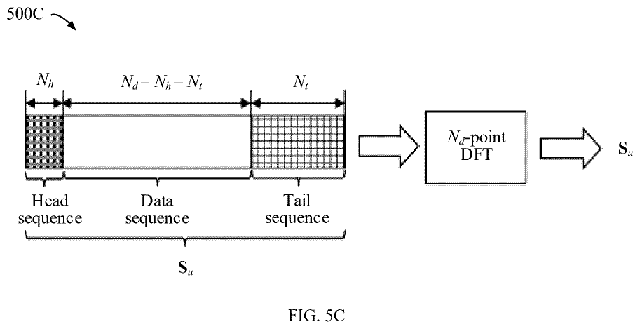

FIG. 5A is a diagram 500A of a generation process of a waveform according to an embodiment of the present disclosure. It is assumed that s₀, s₁, . . . , and s_{L-1} respectively correspond to L data streams. Each stream includes

$${N}_{d} = \frac{{\tilde{N}}_{sc}}{G}$$

pieces of data, where

$${\tilde{N}}_{sc} = ⌊ \frac{{N}_{sc}}{G} ⌋ G .$$

N_{sc} represents a quantity that is of subcarriers and that corresponds to bandwidth allocated by a system, and └·┘ represents a rounding down operator. s₁, . . . , and s_{L-1} each carries a data segment. FIG. 5C shows a structure of the data segment.

The L data streams are precoded to obtain L frequency-domain signals S₀, S₁, . . . , and S_{L-1}. Sᵤ is an N_{d}-dimensional data block. A single stream may be precoded independently, or a plurality of streams may be jointly precoded. FIG. 5A corresponds to a case of single-stream independent precoding. sᵤ (where 0≤u≤L−1, and u is an integer) is precoded to obtain a frequency-domain signal Sᵤ. It should be noted that L precoders in FIG. 5A are related to indexes u of the data streams. In other words, different streams may be precoded differently.

Optionally, multi-stream joint precoding may alternatively be used. It is assumed that a 1^{st} stream corresponds to a user 1, and a 2^{nd} stream to an L^{th} stream correspond to a user 2. The L−1 data streams of the user 2 are precoded jointly. First, the L−1 data streams of the user 2 are arranged by column into an N_{d}*(L−1) matrix A₁. The joint precoding is left-multiplying the matrix A₁ by an N_{d}*N_{d} matrix and right-multiplying the matrix A₁ by an (L−1)*(L−1) matrix. An N_{d}*(L−1) matrix A₂ is output through joint precoding. Columns of the matrix A₂ are respectively used as S₁, . . . , and S_{L-1}. It should be noted that multi-stream precoding is not limited to the foregoing example.

As shown in FIG. 5A, a frequency-domain signal obtained by combining the L frequency-domain signals by a subcarrier distributed mapping module may be described by using an Ñ_{sc}-dimensional data block S. N−Ñ_{sc} zeros are added to the tail of S to obtain an N-dimensional data block X. An N-point inverse discrete Fourier transform (inverse discrete Fourier transform, IDFT) operation is performed on X to obtain a set of N complex time-domain sampling points x.

The following describes the subcarrier distributed mapping module. Subcarrier cross mapping is performed on the L frequency-domain signal, and mapping is performed on each frequency-domain signal at a spacing of G−1 subcarriers. It may be understood as that a frequency-domain signal Sᵤ corresponding to a u^{th} stream data occupies N_{d} subcarriers, which correspond to subcarrier indexes pᵤ:G:(N_{d}−1)G+pᵤ. G is a positive integer greater than or equal to L, and N can be exactly divided by G. The integer pᵤ is in one-to-one mapping with u, and 0≤pᵤ≤G−1. For any integer n E {0, 1, . . . , Ñ_{sc}−1}, if [symbol] n [symbol] =pᵤ, to be specific, a remainder of n divided by G is equal to pᵤ, an n^{th} element of S is

$$S [ n ] = {S}_{u} [ ⌊ \frac{n}{g} ⌋ ] ,$$

where Sᵤ[q] is a q^{th} element of a data block Sᵤ, and └·┘ represents a rounding down operator.

In some embodiments, the symbol x may alternatively be understood as a superposition of L stream signals x₀, x₁, . . . , and x_{L-1}, that is

$$x = {\sum }_{u = 0}^{L - 1} {x}_{u} .$$

FIG. 5B is a diagram 500B of another generation process of a waveform according to an embodiment of the present disclosure. FIG. 5B corresponds to a case of single-stream independent precoding. Based on a process in FIG. 5B, xᵤ may be generated by using sᵤ. As shown in FIG. 5B, subcarrier distributed mapping is performed on Sᵤ to generate an N-dimensional data block Xᵤ. An element Xᵤ[\dot{n}] of the N-dimensional data block X₂ is given by Formula (2), where \dot{n}=0, 1, . . . , N−1:

$${X}_{u} [ \dot{n} ] = \{ \begin{matrix}{S}_{u} [ ⌊ \frac{\dot{n}}{G} ⌋ ] , & if {〈 \dot{n} 〉}_{G} = {p}_{u} and \dot{n} < {\tilde{N}}_{sc} \\ 0 , & otherwise\end{matrix} , \qquad ( 2 )$$

where
Ñ_{sc} represents a quantity of subcarriers occupied by a time-domain signal x.

As shown in FIG. 5B, an N-point IDFT operation may be performed on the N-dimensional data block Xᵤ to obtain a u^{th} signal xᵤ. In this manner, the symbol x can be obtained by superposing the L stream signals x₀, x₁, . . . , and x_{L-1}.

To cause the symbol x to be divided into a plurality of subsymbols whose lengths are the same and whose tail signals are approximately the same, a 0^{th} signal needs to be a periodic signal. This poses an additional requirement on a design of p₀. During subcarrier mapping, if the one-to-one mapping between pᵤ and u is pᵤ=u, p₀=0. From a time-domain perspective, the 0^{th} signal x₀ is a periodic signal in this case, and a periodicity is N_{sub}=N/G. When pᵤ and u are in other one-to-one mapping, in which case p₀≠0, if a common divisor of p₀ and G is greater than 1, from the time-domain perspective, a 0^{th} signal x₀ is also a periodic signal, and a periodicity is

$${N}_{sub} = \frac{N}{{c}_{0}} .$$

c₀ is the common divisor of the p₀ and G. For example, if G=4, L=2, and pᵤ= [symbol] u+2 [symbol] _{G}, to be specific, pᵤ is equal to a remainder of (u+2) divided by G, p₀=2 and N=2048. In this case, c₀=2, and x, is a periodic signal whose periodicity is N_{sub}=1024. For another example, if G=6, L=2, and pᵤ= [symbol] u+3 [symbol] _{G}, to be specific, pᵤ is equal to a remainder of (u+3) divided by G, p₀=3 and N=768. In this case, c₀=3, and x₀ is a periodic signal whose periodicity is N_{sub}=256.

Still refer to FIG. 5A. In some embodiments, any waveform may be used to carry the first data stream s₀. For example, when an OFDM waveform is used, s₀ is a frequency-domain sequence, and precoding matrices in FIG. 5A and FIG. 5B are unit matrices. In some embodiments, an element of s₀ may be a constellation point symbol like QPSK or 16-QAM. In another example, when another waveform like a DFT-s-OFDM waveform, an SC-OQAM waveform, or an OTFS waveform is used, the 0^{th} frequency-domain signal S₀ may be obtained by precoding a sequence of another domain. For example, in an example of DFT-s-OFDM modulation, the another domain is time domain, and the precoding refers to DFT, which is used for transforming a signal from time domain to frequency domain.

In some embodiments, a 1^{st} time-domain signal to an (L−1)th time-domain signal x₁, . . . , and x_{L-1} are all single-carrier signals. FIG. 5C is a diagram 500C of a generation process of a 1^{st} frequency-domain signal to an (L−1)^{th} frequency-domain signal according to an embodiment of the present disclosure. Assuming that DFT-s-OFDM modulation is considered, Sᵤ (u=1, . . . , L−1) may be generated in a manner shown in FIG. 5C. It can be learned that Sᵤ may be obtained by performing N_{d}-point DFT on an N_{d}-dimensional data segment sᵤ.

In an example of FIG. 5C, for the data segment sᵤ, where u=1, . . . , L−1, in addition to a data sequence, the data segment sᵤ includes both a head sequence before the data sequence and a tail sequence after the data sequence. A length of the head sequence is Nₕ, and a length of the tail sequence is Nₜ. A length of the data sequence is N_{d}−Nₕ−Nₜ. In some embodiments, for s₁, . . . , and s_{L-1}, head sequences are the same, and tail sequences are also the same. Both the head sequence and the tail sequence are fixed sequences and do not carry data information. In some embodiments, the data sequence carries N_{d}−Nₕ−Nₜ constellation point symbols such as QPSK or 16-QAM. For s₁, . . . , and s_{L-1}, data sequences are different. It should be understood that the head sequence and the tail sequence are not limited to the foregoing examples, but may be implemented in any appropriate manner.

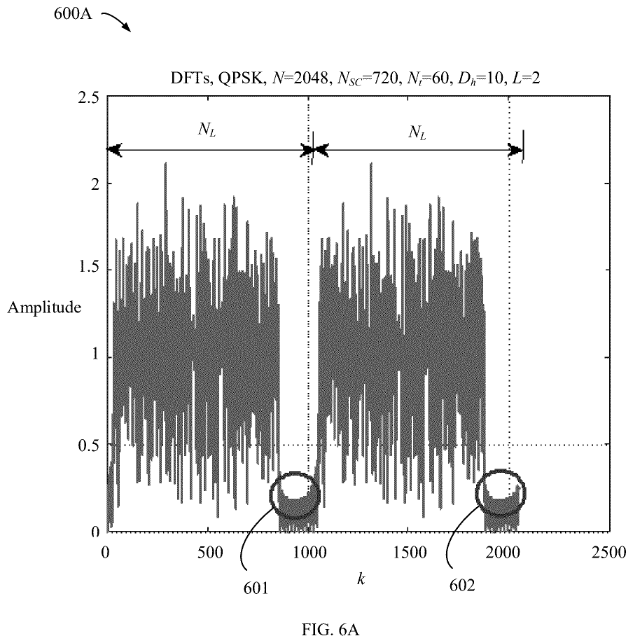

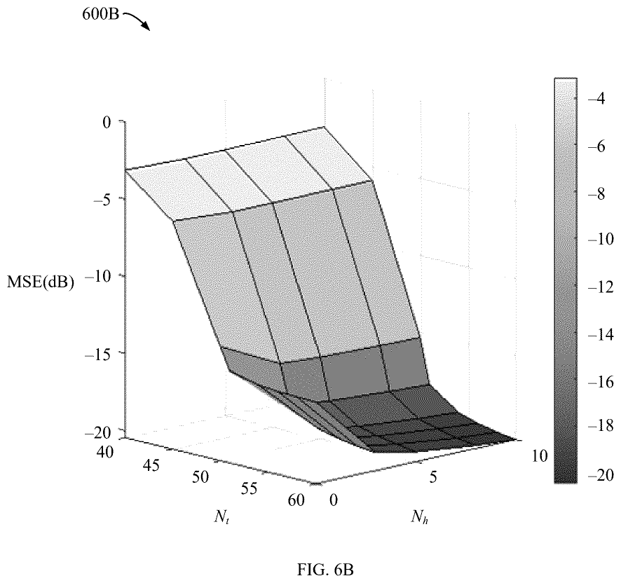

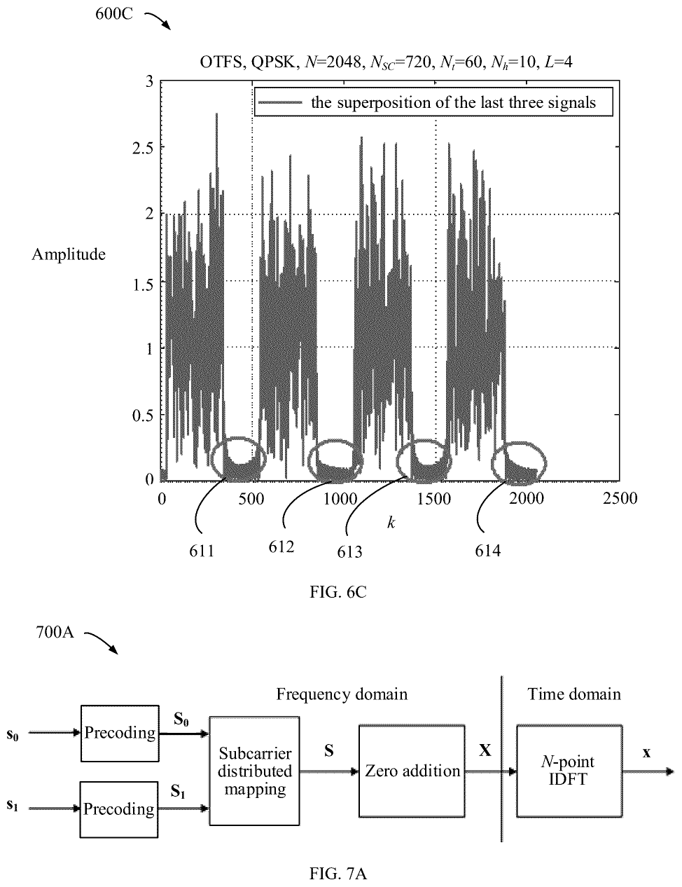

When x₀ is a periodic signal, the symbol x may be divided into L_{sub}=N/N_{sub} subsymbols whose lengths are all N_{sub}, and tail signals (including N₀ sampling values) of the subsymbols are approximately the same, as shown in FIG. 6A below. It should be noted that performing further processing on the symbol x may cause the tail signals of the subsymbols to be completely the same. For example, tail signals of a subsymbol 1 to a subsymbol L_{sub}−1 each are set to be equal to a tail signal of a subsymbol 0.

In some embodiments, a first quantity of front-part sampling points of each subsymbol may be associated with the head sequence, and a second quantity of rear-part sampling points of each subsymbol may be associated with both the head sequence and the tail sequence.

In some embodiments, the first quantity may be determined based on at least one of a length (Nₕ) of the head sequence, a quantity (Ñ_{sc}) of subcarriers occupied by the time-domain signal x, and a quantity (N) that is of sampling points and that corresponds to the time-domain signal. For example, the first quantity may be NNₕ/Ñ_{sc}. It should be understood that this is merely an example, and another manner is also feasible. In some embodiments, the second quantity may be determined based on at least one of a length (Nₜ) of the tail sequence, a quantity (Ñ_{sc}) that is of subcarriers and that corresponds to the set, and the quantity (N) that is of sampling points and that corresponds to the time-domain signal. For example, the second quantity may be NNₜ/Ñ_{sc}. It should be understood that this is merely an example, and another manner is also feasible.

In some embodiments, the length (Nₕ) of the head sequence and the length (Nₜ) of the tail sequence may be associated with at least one of the following: a length of a CP(Q); the quantity (N_{sc}) that is of subcarriers and that corresponds to the set; the quantity (N) that is of sampling points and that corresponds to the time-domain signal; a quantity (G) of subcarriers at a spacing; and an expected MSE level for a difference between the tail signals of the subsymbols.

In some embodiments, the length Nₜ of the tail sequence may be given through Formula (3):

$${N}_{t} = ⌈ Q {\tilde{N}}_{sc} / N ⌉ + a , \qquad ( 3 )$$

where
Nₜ represents the length of the tail sequence, Q represents the length of the CP, Ñ_{sc} represents the quantity of subcarriers occupied by the time-domain signal x, N represents the quantity that is of sampling points and that corresponds to the time-domain signal x, G represents the quantity of subcarriers at a spacing, and a is a preconfigured value or is related to a system parameter. The system parameter includes, for example, the quantity Ñ_{sc} of the subcarriers, a quantity N of IDFT points, and the expected MSE level for the difference between the tail signals of the subsymbols.

In some embodiments, the length Nₕ of the head sequence may be given through Formula (4):

$${N}_{h} = b , \qquad ( 4 )$$

where
b is a preconfigured value or is related to a system parameter. The system parameter includes, for example, the Q length of the CP, the quantity Ñ_{sc} of subcarriers occupied by the time-domain signal x, the quantity N of IDFT points, and the expected MSE level for the difference between the tail signals of the subsymbols.

For example, N=2048*2^{μ}, Q=144*2^{μ}, Ñ_{sc}=720, α may be 5, and b=10, where μ is an integer (0, 1, 2, 3, or 4). This is merely an example, and is not intended to limit the content of the present disclosure.

In some embodiments, an element of a predetermined sequence may be optimized. For example, a PAPR of a symbol including N sampling points in time domain may be minimized when envelope jitter of the combined frequency-domain signal of the L stream signals is limited.

FIG. 6A is a diagram 600A of an envelope of an example signal according to an embodiment of the present disclosure. Assuming that N=2048, Ñ_{sc}=720, Q=144, and G=L=2, ┌QÑ_{sc}/N┐=51. In this case, there are two signals in total. When a DFT-s-OFDM QPSK waveform is used for both the two signals, both the head sequence and the tail sequence are zero sequences. N_{d} subcarriers occupied by a frequency-domain signal Sᵤ corresponding to a u^{th} data stream correspond to subcarrier indexes u:G:(N_{d}−1)G+u. FIG. 6A shows an envelope of a 1^{st} signal x₁ when Nₜ=60 and Nₕ=10, where k represents a sampling point index. It can be learned that parts of the envelope of x₁ at positions indicated by numbers 601 and 602 are approximately equal. Based on this feature and the feature that the 0^{th} signal is a periodic signal whose periodicity is N_{sub}, the tail signals (including the N₀ sampling values) of the subsymbols whose lengths are N_{sub}=1024 and that are obtained by dividing the symbol x are the same.

FIG. 6B is a diagram 600B of an MSE simulation result according to an embodiment of the present disclosure. FIG. 6B shows an MSE result based on different Nₜ and Nₕ, and other parameters are the same as those used for drawing 6A. It can be learned that, when Nₕ is fixed, an MSE decreases monotonically as Nₜ increases. When Nₜ exceeds 51, the MSE decreases insignificantly. In addition, increasing Nₕ causes a further decrease in the MSE. When Nₜ=56 (that is, a=5) and Nₕ=10, a value of the MSE is 10⁻².

It is assumed that N=2048, N_{sc}=720, Q=144, G=L=4, Nₜ=60, and Nₕ=10. A DFT-s-OFDM QPSK waveform is used for a 0^{th} signal, an OTFS QPSK waveform is used for a 1^{st} signal to a 3^{rd} signal, and a 2^{nd} data stream to a 4th data stream are jointly precoded. Steps of the joint precoding includes: arranging three data streams by column to form an N_{d}×(L−1) matrix A₁; performing N_{d}-point DFT on each column of the matrix A₁, performing (L−1)-point IDFT on each row of the matrix A₁, to obtain an N_{d}*(L−1) matrix A₂; and respectively using columns of the matrix A₂ as S₁, . . . , and S_{L-1}. N_{d} subcarriers occupied by a frequency-domain signal Sᵤ corresponding to a u^{th} data stream correspond to subcarrier indexes u:G:(N_{d}−1)G+u. FIG. 6C is a diagram 600C of an envelope of a superposition of three example signals (for example, an envelope of a signal obtained through superposition of a 1^{st} signal to a 3^{rd} signal x₁, x₂, and x₃) under joint precoding according to an embodiment of the present disclosure. It can be learned that parts of the envelope at positions indicated by numbers 611, 612, 613, and 614 are approximately equal. Based on a combination of this feature “approximate equivalence of the envelope” and the feature that “the 0^{th} signal is a periodic signal whose periodicity is N_{sub}”, the tail signals (including N₀ sampling values) of the subsymbols whose lengths are N_{sub} and that are obtained by dividing the symbol x are approximately the same.

In this manner, when the fixed head sequence and the fixed tail sequence are introduced, and specific spectral efficiency is sacrificed, significant interference between signal blocks and significant interference in the signal block when a received signal is divided into blocks can be avoided. Communication processing and sensing processing are performed based on a signal block obtained by dividing the received signal at a granularity of a length of a subsymbol. This can maximally increase a maximum unambiguous Doppler frequency by L_{sub} times (where L_{sub} is a quantity of subsymbols). In addition, a frequency-domain signal corresponding to the signal block has a larger subcarrier spacing. This can help optimize demodulation performance of a communication receiver in a high Doppler scenario.

In addition, the solution of the foregoing embodiment may be extended to a general case: L−U streams include a data segment, and U streams include no data segment, where U is an integer less than L, including: U=0, or U is equal to 1, or U is a positive integer that can be exactly divided by G (or U is a common divisor of G and N). The foregoing embodiment corresponds to a case in which U is equal to 1. The following analyzes other cases.

In some embodiments, U=0. A data segment is added to each stream. However, in this solution, both spectral efficiency and a PAPR of a waveform are worse than those in a case in which U=1.

In some embodiments, U is a positive integer that can be exactly divided by G. It is assumed that G=4, L=3, N=2048, and U=2. In this case, there are two streams that include no data segment. It is assumed that the two data streams are denoted as s₀ and s₁. Indexes of subcarriers occupied by frequency-domain signals S₁ and S₂ corresponding to the two data streams are respectively 0:G:(Ñ_{d}−1) G and 2:G:(N_{d}−1)G+2, and generated time-domain signals x₀ and x₁ are respectively 512 and 1024. Therefore, the time-domain signal x may be divided into two subsymbols whose lengths are both 1024, and tail signals of the subsymbols are approximately the same.

In some embodiments, U is a common divisor of G and N. It is assumed that G=6, L=4, N=768, and U=3. In this case, there are three streams that include no data segment. It is assumed that the three streams are denoted as so, S₁, and $2. Indexes of subcarriers occupied by frequency-domain signals S₁, S₂, and S₃ corresponding to the three data steams are respectively 0:G:(N_{d}−1)G, 3:G:(N_{d}−1)G+3, and 2:G:(N_{d}−1)G+2, and generated time-domain signals x₀, x₁, and x₂ are respectively 128, 256, and 384. Therefore, the time-domain signal x may be divided into three subsymbols whose lengths are all 384, and tail signals of the subsymbols are approximately the same.

In an embodiment, the set of data streams includes: one first data stream including at least one data segment; and one second data stream. That is, the set includes two data streams (that is, L is equal to 2). Considering an uplink scenario, the two data streams may be from two users, or may be from one user. Considering a downlink scenario, the two data streams may be data sent by a base station to two users, or may be data sent by the base station to one user.

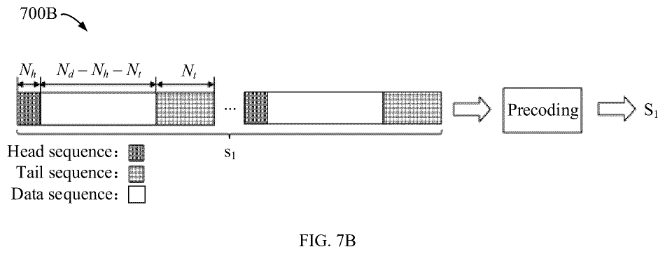

FIG. 7A is a diagram 700A of another generation process of a waveform according to an embodiment of the present disclosure. It is assumed that there are two data streams s₀ and s₁. s₀ corresponds to the second data stream, and s₁ corresponds to the first data stream including at least one data segment. s₀ includes N_{d}=Ñ_{sc}/G pieces of data, where

$${\tilde{N}}_{sc} = ⌊ \frac{{N}_{sc}}{G} ⌋ G ,$$

N_{sc} represents a quantity that is of subcarriers and that corresponds to bandwidth allocated by a system, and └·┘ represents a rounding down operator. s₁ includes K data segments, and a length of each data segment is N_{d}. K is an integer greater than or equal to 1 and less than G.

As shown in FIG. 7A, sᵤ (0≤u≤1) is precoded to obtain a frequency-domain signal Sᵤ. S₀ is an N_{d}-dimension data block. S₁ is a (K*N_{d})-dimensional data block. Inputs of a subcarrier distributed mapping module are S₀ and S₁, to generate a frequency-domain signal S. S is an Ñ_{sc}-dimensional data block. N−Ñ_{sc} zeros are added to the tail of S to obtain an N-dimensional data block X. An N-point IDFT operation is performed on X to obtain a set of N complex time-domain sampling points x.

The following describes the subcarrier distributed mapping module. A subcarrier occupied by S₀ corresponds to a subcarrier index p₀:G:(N_{d}−1)G+p₀. An integer G is greater than K. p₀ is an integer, and 0≤p₀≤G−1. Before subcarrier mapping is performed on S₁, S₁ is first converted into a K*N_{d} matrix through serial-to-parallel conversion. A subcarrier occupied by N_{d} pieces of data in a k^{th} row of the matrix corresponds to a subcarrier index {pₖ:G:(N_{d}−1)G+pₖ}. 0≤pₖ≤G−1, and p₀, p₁, . . . , and p_{K} are not equal. If pᵤ=u, u=0, . . . , K, an n^{th} element S[n] of S is as follows, where n=0, 1, . . . , Ñ_{sc}−1,

$$S [ n ] = \{ \begin{matrix}{S}_{0} [ \frac{n}{G} ] , & if {〈 n 〉}_{G} = 0 \\ {S}_{1} [ ( G - 1 ) ⌊ \frac{n}{G} ⌋ + {〈 n 〉}_{G} - 1 ] , & if {〈 n 〉}_{G} \neq 0\end{matrix} ,$$

where
Sᵤ[q] (u=0,1) is a q^{th} element of a data block Sᵤ, └·┘ represents a rounding down operator, and [symbol] n [symbol] _{G} is for calculating a remainder of n divided by G.

In some embodiments, the symbol x may alternatively be understood as a superposition of two signals x₀ and x₁, that is, x=x₀+x₁. Based on a process in FIG. 5B, x₀ is generated by using S₀ and x₁ is generated by using S₁. For an N-dimensional data block X₀, an element other than N_{d} elements: X₀[0]=S₀[0], X₀[G]=S₀[1], . . . , and X₀[(N_{d}−1)G]=S₀[N_{d}−1] is equal to 0. If pₖ=k, k=1, . . . , K, an element X₁[\dot{n}] of an N-dimensional data block X₁ is given by Formula (5), where \dot{n}=0, 1, . . . , N−1:

$${X}_{1} [ \dot{n} ] = \{ \begin{matrix}{S}_{1} [ ( G - 1 ) ⌊ \frac{\dot{n}}{G} ⌋ + {〈 \dot{n} 〉}_{G} - 1 ] , & if {〈 \dot{n} 〉}_{G} \neq 0 and \dot{n} < {\tilde{N}}_{sc} \\ 0 , & otherwise\end{matrix} \qquad ( 5 )$$

An N-point IDFT operation may be performed on the N-dimensional data block X₁ to obtain a 1^{st} signal x₁. In this manner, the symbol x can be obtained by superposing the two signals x₀ and x₁.

To cause the symbol x to be divided into a plurality of subsymbols whose lengths are the same and whose tail signals are approximately the same, a 0^{th} signal needs to be a periodic signal. This poses an additional requirement on a design of p₀. During subcarrier mapping, if one-to-one mapping between pᵤ and u is pᵤ=u, p₀=0. From a time-domain perspective, the 0th signal x, is a periodic signal in this case, and a periodicity is N_{sub}=N/G. When pᵤ and u are in other one-to-one mapping for enabling p₀+0, if a common divisor of p₀ and G is greater than 1, from the time-domain perspective, a 0^{th} signal x₀ is also a periodic signal, and a periodicity is

$${N}_{sub} = \frac{N}{{c}_{0}} .$$

c₀ is the common divisor of the p₀ and G. For example, if G=4 and pᵤ= [symbol] u+2 [symbol] _{G}, to be specific, pᵤ is equal to a remainder of (u+2) divided by G, p₀=2 and N=2048. In this case, c₀=2, and x, is a periodic signal whose periodicity is N_{sub}=1024. For another example, if G=6 and pᵤ= [symbol] u+3 [symbol] _{G}, to be specific, pᵤ is equal to a remainder of (u+3) divided by G, p₀=3 and N=768. In this case, c₀=3, and x₀ is a periodic signal whose periodicity is N_{sub}=256.

Still refer to FIG. 7A. In some embodiments, any waveform may be used for the 0th signal. For example, when an OFDM waveform is used, s₀ is a frequency-domain sequence, and a precoding matrix in FIG. 7A is a unit matrix. In another example, when another waveform like a DFT-s-OFDM waveform, an SC-OQAM waveform, or an OTFS waveform is used, S₀ may be obtained by precoding a sequence of another domain. For example, in an example of the DFT-s-OFDM waveform, s₀ is a time-domain sequence, and the precoding refers to DFT, which is used for transforming a signal from time domain to frequency domain.

In some embodiments, the 1^{st} signal is a single-carrier signal. FIG. 7B is a diagram 700B of a generation process of a 1^{st} frequency-domain signal S₁ according to an embodiment of the present disclosure. S₁ includes K data sequences whose lengths are all N_{d}−Nₕ−Nₜ. Each data sequence is preceded by a head sequence whose length is Nₕ and followed by a tail sequence whose length is Nₜ. Both the head sequence and the tail sequence are fixed sequences and do not carry information. The data sequence may carry information. For example, an element is a constellation point symbol like QPSK or 16-QAM; or the data sequence may not carry information. For example, an element is a pilot symbol. Generally, data sequences are different.

Assuming that a DFT-s-OFDM waveform is considered, precoding in FIG. 7B is (KN_{d})-point DFT. Assuming that OTFS modulation is considered, s₁ in FIG. 7B is first rearranged into an N_{d}*K matrix A₁. Precoding means performing N_{d}-point DFT on each column of the matrix A₁, and performing K-point IDFT on each row of the matrix A₁. An N_{d}*K matrix A₂ is obtained through the precoding. The matrix A₂ is expanded by row to obtain S₁. It should be noted that a precoding implementation of the OTFS modulation is not limited to the foregoing descriptions.

When x₀ is a periodic signal, the symbol x may be divided into L_{sub}=N/N_{sub} subsymbols whose lengths are all N_{sub}, and tail signals (including N₀ sampling values) of the subsymbols are approximately the same. It should be noted that performing further processing on the symbol x may cause the tail signals of the subsymbols to be completely the same. For example, tail signals of a subsymbol 1 to a subsymbol L_{sub}−1 each are set to be equal to a tail signal of a subsymbol 0.

In this manner, when the fixed head sequence and the fixed tail sequence are introduced, and specific spectral efficiency is sacrificed, significant interference between signal blocks and significant interference in the signal block when a received signal is divided into blocks can be avoided. Communication processing and sensing processing are performed based on a signal block obtained by dividing the received signal at a granularity of a length of a subsymbol. This can maximally increase a maximum unambiguous Doppler frequency by L_{sub} times (where L_{sub} is a quantity of subsymbols). In addition, a frequency-domain signal corresponding to the signal block has a larger subcarrier spacing. This can help optimize demodulation performance of a communication receiver in a high Doppler scenario.

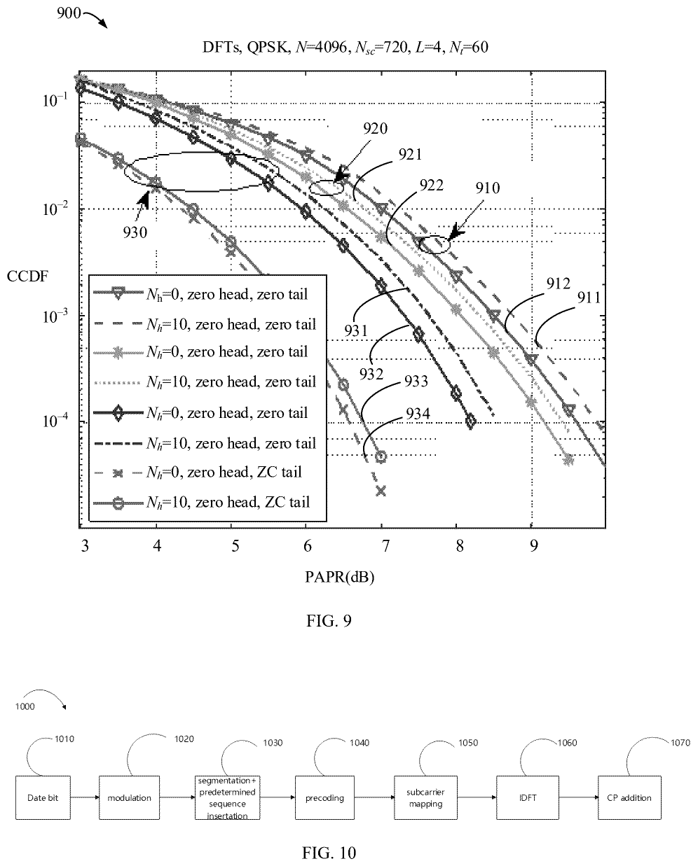

When K=1, this embodiment is the same as the foregoing embodiment in which L=2. For any K=L−1, from a spectral efficiency perspective, this embodiment and the foregoing embodiments have same frequency efficiency. However, when K≥2, a waveform x generated in this embodiment has a lower PAPR. Details are provided later with reference to FIG. 9.

In addition, the solution of this embodiment may be extended to a plurality of streams. For example, transmission of three streams s₀, s₁, and s₂ are performed. s₀ and a processing manner thereof are the same as those in Embodiment 2. s₁ and s₂ respectively carry K₁ data segments and K₂ data segments. A structure of the data segment is as described in Embodiment 2. Both K₁ and K₂ are positive integers, and K₁+K₂+1≤G. Processing manners of frequency-domain signals S₁ and S₂ corresponding to s₁ and s₂ are the same as a processing manner of S₁ in Embodiment 2.

In some embodiments, the set of data streams may include only one data stream, and the data stream includes the plurality of data segments. In this embodiment, the second data stream described in the foregoing embodiment does not exist, and only the first data stream is included.

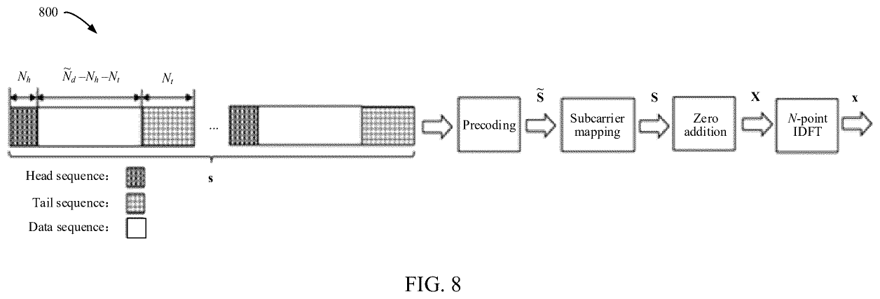

FIG. 8 is a diagram 800 of another generation process of a waveform according to an embodiment of the present disclosure. In this example, s whose length is N_{d}=Ñ_{sc}/G includes K data segments, where

$${\tilde{N}}_{sc} = ⌊ \frac{{N}_{sc}}{G} ⌋ G ,$$

N_{sc} represents a quantity that is of subcarriers and that corresponds to bandwidth allocated by a system, and └·┘ represents a rounding down operator. A length of each data segment is Ñ_{d}=N_{d}/K. A data sequence whose length is Ñ_{d}−Nₕ−Nₜ is included in the middle of the data segment. Each data sequence is preceded by a head sequence whose length is Nₕ and followed by a tail sequence whose length is Nₜ. Both the head sequence and the tail sequence are fixed sequences and do not carry information. In some embodiments, the data sequence may carry information. For example, an element is a constellation point symbol like QPSK or 16-QAM. In some embodiments, the data sequence may not carry information. For example, an element is a pilot symbol. Generally, data sequences are different. For other details about the head sequence and the tail sequence, refer to the descriptions in the foregoing embodiments. Details are not described herein again.

As shown in FIG. 8, s is precoded to obtain an N_{d}-dimensional data block \tilde{S}. Mapping is performed on \tilde{S} at a spacing of (G−1) subcarriers to obtain an Ñ_{sc}-dimensional frequency-domain data block S. N−Ñ_{sc} zeros are added to the tail of S to obtain an N-dimensional data block X. An N-point IDFT operation is performed on X to obtain a symbol x including N complex time-domain sampling points.

In some embodiments, the quantity of the plurality of subsymbols may be associated with at least one of the following: a subcarrier mapping spacing associated with subcarrier mapping included in processing; the quantity (donated as K) of data segments; or a quantity (donated as N) that is of sampling points and that corresponds to a time-domain signal. In some embodiments, the quantity of the plurality of subsymbols may be K*G. Both G and K are positive integers, and N_{d} can be exactly divided by K, where G*K≥2.

In some embodiments, if N can be exactly divided by G*K, the symbol x may be divided into G*K subsymbols whose lengths are all N_{sub}=N/G/K, and tail signals (including N₀ sampling values) of the subsymbols are approximately the same.

In some embodiments, if N cannot be exactly divided by G*K, cannot be exactly divided by K, but can be exactly divided by G, the symbol x may be divided into G subsymbols whose lengths are all N_{sub}=N/G, and tail signals (including N₀ sampling values) of the subsymbols are approximately the same.

In some embodiments, if N cannot be exactly divided by G*K, cannot be exactly divided by G, but can be exactly divided by K, the symbol x may be divided into K subsymbols whose lengths are all N_{sub}=N/K, and tail signals (including N₀ sampling values) of the subsymbols are approximately the same.

Further processing is performed on the time-domain sampling points (that is, the symbol x), so that the tail signals of the subsymbols are completely the same. For example, tail signals of a 1^{st} subsymbol to a last subsymbol each are set to be equal to a tail signal of a subsymbol 0.

x is a single-carrier signal. Assuming that DFT-s-OFDM modulation is considered, precoding in FIG. 8 is N_{d}-point DFT. Assuming that OTFS modulation is considered, steps of the precoding may include: first, rearranging s₁ to form an Ñ_{d}*K matrix A₁; and then performing Ñ_{d}-point DFT on each column of the matrix A₁, and performing K-point IDFT on each row of the matrix A₁. An Ñ_{d}*K matrix A₂ is obtained through the precoding. The matrix A₂ is expanded by row to obtain \tilde{S}. It should be noted that a precoding implementation of the OTFS modulation is not limited thereto, and any other appropriate manner is also feasible.

In comparison with the foregoing embodiment, this embodiment implements lower spectral efficiency. It is assumed that all subcarriers corresponding to an allocated spectrum are occupied and the lengths of the subsymbols are the same. In the foregoing embodiment, a proportion of the head sequence and the tail sequence is (Nₕ+Nₜ) (G−1)/N_{sc}, and in this embodiment, a proportion of a head sequence and a tail sequence is (Nₕ+Nₜ) G/N_{sc}. However, a signal generated in this embodiment has a lower PAPR than a signal generated in the foregoing embodiment. The following provides detailed descriptions with reference to FIG. 9.

FIG. 9 is a curve diagram 900 of PAPR comparison of waveforms for solutions according to an embodiment of the present disclosure; In this example, it is assumed that N=4096, N_{sc}=720, Q=288, and Nₜ=60. A DFT-s-OFDM QPSK waveform is used. For Embodiment 1, G=L=4, N_{d} subcarriers occupied by the frequency-domain signal Sᵤ corresponding to the u^{th} stream data correspond to the subcarrier indexes u:G:(N_{d}−1)G+u; for Embodiment 2, K=3 and pᵤ=u, for u=0, . . . , K; and for Embodiment 3, G=1 and K=4. As shown in FIG. 9, an arrow 910 indicates a result of an embodiment in which a plurality of first data streams and one or more second data streams are included; a curve 911 represents a simulation result for this embodiment when Nₕ=10 and a head sequence and a tail sequence are zero sequences; and a curve 912 represents a simulation result for this embodiment when Nₕ=0 and a head sequence and a tail sequence are zero sequences. An arrow 920 indicates a result of an embodiment in which one first data stream and one second data stream are included; a curve 921 represents a simulation result for this embodiment when Nₕ=10 and a head sequence and a tail sequence are zero sequences; and a curve 922 represents a simulation result for this embodiment when Nₕ=0 and a head sequence and a tail sequence are zero sequences. An arrow 930 indicates a result of an embodiment in which only one data stream is included; a curve 931 represents a simulation result for this embodiment when Nₕ=10 and a head sequence and a tail sequence are zero sequences; a curve 932 represents a simulation result for this embodiment when Nₕ=0 and a head sequence and a tail sequence are zero sequences; a curve 933 represents a simulation result for this embodiment when Nₕ=10, a head sequence is a zero sequence, and a tail sequence is a Zadoff-Chu (ZC) sequence; and a curve 934 represents a simulation result for this embodiment when Nₕ=0, a head sequence is a zero sequence, and a tail sequence is a ZC sequence.

It can be learned from FIG. 9 that, when Nₕ=0, compared with a waveform generated in the embodiment in which a plurality of first data streams and one or more second data streams are included, a waveform generated in the embodiment in which a one first data stream and one second data stream are included has a PAPR gain of 0.5 dB when a complementary cumulative distribution function (CCDF) is 10⁻². A signal generated in the embodiment in which only one data stream is included has a lower PAPR than that generated in the embodiment in which a plurality of first data streams and one or more second data streams are included and that generated in the embodiment in which a one first data stream and one second data stream are included. Further, the waveform PAPR can be further improved by optimizing a fixed sequence (for example, using a ZC sequence).

At this point, the generation process of the waveform is described. The following describes a processing process of the waveform with reference to FIG. 10. FIG. 10 is a diagram of a processing process 1000 of a transmitted signal according to an embodiment of the present disclosure. The process 1000 may be implemented at a transmit device (for example, the communication device 110). As shown in FIG. 10, in step 1010, the communication device 110 may generate a to-be-transmitted data bit sequence.

In step 1020, the communication device 110 may modulate the data bit sequence to map the data bit sequence into an information symbol sequence.

In step 1030, the communication device 110 may segment the information symbol sequence, and then insert a predetermined sequence into at least one of the head and the tail of each segment, to obtain a set of data streams. This step may be implemented based on any implementation of the foregoing embodiments, and details are not described herein.

In step 1040, the communication device 110 may precode the set of data streams to obtain a set of frequency-domain streams. In some embodiments for DFT-s-OFDM modulation, precoding may be DFT transform. To be specific, a time-domain symbol sequence is transformed into a frequency-domain signal. In some embodiments for OFDM modulation, precoding may be understood as a unit matrix, and an input and an output of a precoding module are the same. In some embodiments for OTFS modulation, precoding may be a two-dimensional inverse symplectic finite Fourier transform to transform data in delay-Doppler domain to data in time-frequency domain.

In some embodiments, the communication device 110 may determine, based on an index of one data stream in the set of data streams, a method for precoding the data stream. In this way, single-stream independent precoding can be implemented. In some embodiments, the communication device 110 may determine, based on indexes of a plurality of data streams in the set of data streams, a method for precoding the plurality of data streams. In this way, multi-stream joint precoding can be implemented.

In step 1050, the communication device 110 may perform subcarrier mapping on a frequency-domain stream in the set of frequency-domain streams, to map the frequency-domain stream to a corresponding subcarrier used for signal transmission. In some embodiments, the communication device 110 may determine, based on at least one of an index of the frequency-domain stream, a signal length corresponding to the frequency-domain stream, or a subcarrier mapping spacing associated with the subcarrier mapping, a subcarrier index corresponding to the frequency-domain stream.

For example, it is assumed that L frequency-domain signals occupy a contiguous spectrum with a length of N_{sc} subcarriers in a cross manner, and each frequency-domain signal occupies N_{d}=Ñ_{sc}/G subcarriers in frequency domain, where Ñ_{sc}=G└N_{sc}/G┘. Mapping is performed at a spacing of G−1 subcarriers. An index of a subcarrier occupied by a u^{th} (0≤u≤L−1) frequency-domain signal may be determined by using Formula (6):

$$M = ( {N}_{d} - 1 ) * G + {p}_{u} , \qquad ( 6 )$$

M represents the subcarrier index, N_{d} represents the quantity of subcarriers occupied by each frequency-domain signal, G represents a subcarrier spacing, an integer pᵤ is in one-to-one mapping with u, and 0≤pᵤ≤G−1. The one-to-one mapping that satisfies a requirement is pᵤ=u.

In some embodiments, the subcarrier mapping spacing may be associated with at least one of the following: a quantity of data streams in the set of data streams; a quantity of a plurality of subsymbols; or a quantity (denoted as N) that is of sampling points and that corresponds to a time-domain signal. It is assumed that mapping is performed, at a spacing of G−1 subcarriers, on a frequency stream corresponding to the data stream, where G is a positive integer greater than or equal to the quantity of data streams. In some embodiments, N may be exactly divided by G.

In step 1060, the communication device 110 may perform frequency-domain to time-domain transform (for example, IDFT) on an obtained frequency-domain signal, to obtain the time-domain signal.

In step 1070, the communication device 110 may add a CP to the time-domain signal for sending. The time-domain signal to which the CP is added may correspond to the time-domain signal described with reference to FIG. 4.

Still refer to FIG. 3. At block 330, the communication device 110 may send the time-domain signal to which the CP is added. For example, the communication device 110 may transmit a baseband signal to a radio frequency module for sending.

At this point, the sending method implemented at the transmit end according to embodiments of the present disclosure is described. In the method, modulated data is processed, to obtain a time-domain signal including a cyclic prefix and a plurality of subsymbols. Only tail signals of the subsymbols are the same. In this manner, significant interference between signal blocks and significant interference in the signal block when a received signal is divided into blocks can be avoided. In addition, communication processing and sensing processing can be performed based on a signal block obtained by dividing the received signal at a granularity of a length of the subsymbol. This can maximally increase a maximum unambiguous Doppler frequency by L_{sub} times (where L_{sub} is a quantity of subsymbols). In addition, a frequency-domain signal corresponding to the signal block has a larger subcarrier spacing. This can help optimize demodulation performance of a communication receiver in a high Doppler scenario.

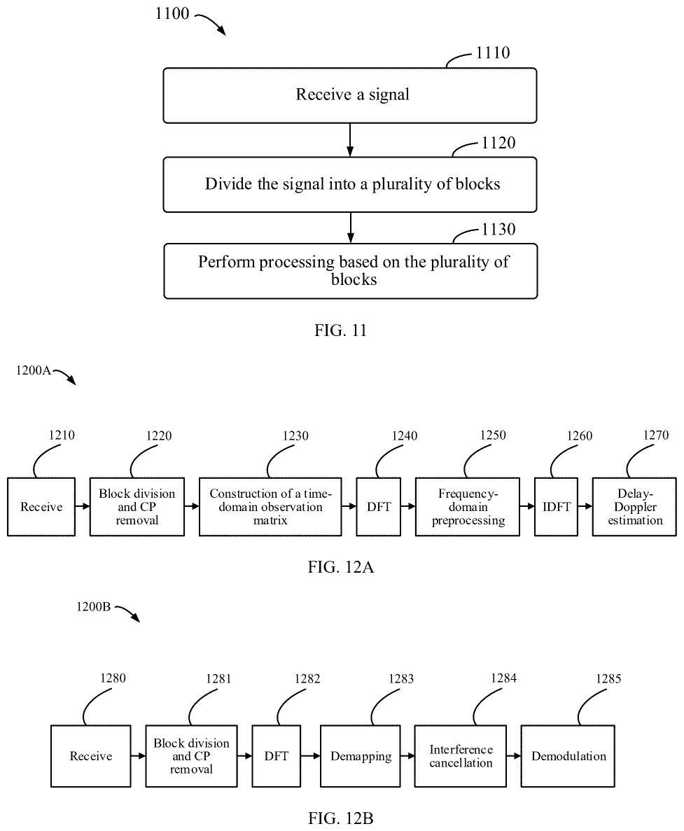

An embodiment of the present disclosure further provides a receiving method implemented at a receive end and corresponding to the foregoing method. FIG. 11 is a schematic flowchart of a receiving method 1100 according to an embodiment of the present disclosure. The method 1100 may be implemented at a receiving device (for example, the communication device 110 in FIG. 1), for example, may be implemented in an IC of the receiving device. For convenience, FIG. 11 is described herein with reference to the example in FIG. 1. It should be understood that the method 1100 in FIG. 11 may include other additional steps that are not shown, or some shown steps may be omitted. The scope of the present disclosure is not limited thereto.

As shown in FIG. 11, at block 1110, the communication device 110 may receive a signal, where the signal includes a cyclic prefix and a plurality of subsymbols.

At block 1120, the communication device 110 may perform preprocessing on the received signal to obtain a plurality of blocks. In some embodiments, the communication device 110 may divide the received signal into the plurality of blocks based on lengths (N_{sub}) of the subsymbols and a length (Q) of the CP, to cause an overlap to exist between two adjacent blocks in the plurality of blocks. In some embodiments, a length of the overlap may be equal to the length of the cyclic prefix.

At block 1130, the communication device 110 may perform processing based on the plurality of blocks. In some embodiments, the communication device 110 may remove a third quantity of front-part sampling values of each of the plurality of blocks, to obtain a plurality of processed blocks, where the third quantity corresponding to the length of the CP. For example, a time-domain signal is an echo signal y(p) that includes N_{sym}(N+Q) sampling points and that corresponds to a sent signal frame, where p=0, 1, . . . , N_{sym}(N+Q)−1. The echo signal may be divided into blocks whose length is N_{sub}+Q, and a quantity of blocks [symbol] (k) is L_{sub}N_{sym}, where [symbol] =0, 1, . . . , L_{sub} N_{sym}−1; and k=0, 1, . . . , N_{sub}+Q−1. There is an overlap of Q sampling values between a remaining block other than N_{sym} blocks: (mL_{sub})^{th}, where m=0, 1, . . . , N_{sym}−1 and a preceding block of the remaining block. Then, first Q sampling values (that is, a CP) of each block are removed to obtain [symbol] (κ), where [symbol] =0, 1, . . . , L_{sub}N_{sym}−1; and κ=0, 1, . . . , N_{sub}−1.

Based on the plurality of processed blocks, the communication device 110 may perform communication or perception processing. In some embodiments, the received signal is an echo signal from a target. In this case, the communication device 110 may perform sensing processing. In some embodiments, the plurality of signal blocks may be used as inputs of a 2D-DFT-based range-Doppler estimation algorithm, to obtain a delay estimate and a Doppler estimate corresponding to a sensing target. The following describes some example embodiments with reference to FIG. 12.

FIG. 12A is a diagram of a processing process 1200A of an echo signal according to an embodiment of the present disclosure. The process 1200A may be implemented at a receiving device (for example, a sensing receiver of a communication device 110). As shown in FIG. 12A, in step 1210, the communication device 110 may receive an echo signal. For example, processing such as down-conversion and sampling is performed on the signal from a radio frequency module, to obtain a discrete-time baseband signal. Step 1210 corresponds to step 1110 described in FIG. 11, and other details are not described herein again.

In step 1220, the communication device 110 may divide the baseband signal into a plurality of blocks based on a length of a subsymbol and a length of a CP, and then remove a front-part sampling value that corresponds to the length of the CP and that is of each of the plurality of blocks. Step 1220 corresponds to steps 1120 and 1130 described in FIG. 11, and other details are not described herein again.

In step 1230, the communication device 110 may construct a time-domain observation matrix by arranging the plurality of blocks by column, for example, construct an N_{sub}*L_{sub} N_{sym} time-domain observation matrix y by arranging a plurality of blocks [symbol] (κ) by column, where [symbol] =0, 1, . . . , L_{sub} N_{sym}−1; and κ=0, 1, . . . , N_{sub}−1. An element in a k^{th} row and an m^{th} column of the matrix y is yₘ(k).

In step 1240, the communication device 110 may perform N_{sub}-point DFT on each column of the matrix y, to obtain a frequency-domain observation matrix Y. A dimension of the matrix Y is N_{sub}*L_{sub} N_{sym}.

In step 1250, the communication device 110 may perform frequency-domain preprocessing on the matrix Y. The preprocessing may be point-by-point division by transmit frequency-domain communication data, or may be point-by-point multiplication by a conjugate of the transmit frequency-domain communication data. In this way, impact of the transmit data is eliminated or matching filtering is performed. A plurality of preprocessed subsymbols are used to construct an N_{sub}*L_{sub} N_{sym} matrix Y based on a subcarrier index and a symbol index.

In step 1260, the communication device 110 may perform N_{sub}-point IDFT (also referred to as range IDFT) on each column of the matrix Y (for example, in a subcarrier index direction), to obtain an N_{sub}*L_{sub} N_{sym} matrix Z (where an m^{th} column of the matrix Z is equal to an IDFT result of an m^{th} column of Y), and may perform L_{sub} N_{sym} DFT (also referred to as Doppler DFT) on each row of the matrix Z (for example, in a symbol index direction), to obtain a delay-Doppler image matrix W (where a dimension is N_{sub}*L_{sub} N_{sym}, and a k^{th} row of the matrix W is equal to a DFT result of a k^{th} row of Z). The row of the matrix represents a delay, and the column represent Doppler.

In step 1270, the communication device 110 may perform peak search or another detection algorithm (for example, a constant false alarm rate detector in the radar field) on the matrix W, to obtain a delay estimate and a Doppler estimate corresponding to a sensing target. Based on the delay estimate and the Doppler estimate, distance and speed information of the target can be derived.

It should be understood that any other appropriate sensing processing known or developed in the future is also feasible, and is not limited to the foregoing delay estimate and Doppler estimate.

FIG. 12B is a diagram of a processing process 1200B of a communication signal according to an embodiment of the present disclosure. The process 1200B may be implemented at a receiving device (for example, a communication receiver of a communication device 110). As shown in FIG. 12B, in step 1280, the communication device 110 may receive a signal (referred to as a communication signal in this specification) through a communication channel. For example, processing such as down-conversion and sampling is performed on the signal from a radio frequency module, to obtain a discrete-time baseband signal. Step 1280 corresponds to step 1110 described in FIG. 11, and other details are not described herein again.

In step 1281, the communication device 110 may divide the baseband signal into a plurality of blocks based on a length of a subsymbol and a length of a CP, and then remove a front-part sampling value that corresponds to the length of the CP and that is of each of the plurality of blocks. Step 1281 corresponds to steps 1120 and 1130 described in FIG. 11, and other details are not described herein again.

In step 1282, the communication device 110 may perform DFT on a signal corresponding to the plurality of blocks, to transform the time-domain signal to a frequency-domain signal.

In step 1283, the communication device 110 may perform subcarrier demapping on the transformed frequency-domain signal.

In step 1284, the communication device 110 may perform an interference cancellation operation on the demapped signal, to remove interference jointly introduced by a channel and a non-ideal device, such as inter-subcarrier interference and phase noise, so as to obtain an estimate of a transmit data symbol. During interference cancellation, switching of a signal from a frequency domain to another domain may be involved, and some domain transform (for example, IDFT) operations are needed.

In step 1285, the communication device 110 may demodulate an interference-cancelled signal, to obtain data bit information.

It should be understood that any other appropriate communication processing known or developed in the future is also feasible, and is not limited to the process shown in FIG. 12B. The receiving method 1100 corresponds to the sending method 300, and therefore other details are not described herein again.

At this point, the receiving method according to embodiments of the present disclosure is described. In the method, block division processing is performed on the received signal based on the length of the subsymbol and the length of the CP, to avoid significant interference between blocks and significant interference in the block, so that processing of an echo signal with respect to a waveform and a communication signal is optimized, to improve accuracy of a sensing signal and accuracy of communication information demodulation.

In conclusion, from a sensing perspective, in embodiments of the present disclosure, interference between frequency-domain subcarriers can be reduced, and sensing performance such as delay estimation performance and an unambiguous Doppler frequency can be improved. For example, a signal frame includes N_{sym} symbols each including a CP. It is assumed that an m^{th} symbol including the CP is denoted as \tilde{x}ₘ, and a non-CP part of the symbol is denoted as xₘ. Because xₘ may be regarded as a concatenation of L_{sub} subsymbols, the L_{sub} subsymbols are denoted as x_{m,l}, l∈{0, 1, . . . , L_{sub}−1}, and x_{m,l}∈ [symbol] ^{N}^{_{sub}}⁺¹.

Assuming that Xml corresponds to a frequency-domain signal X_{m,l}=[x_{m,l}(0), x_{m,l}(1), . . . , x_{m,l}(N_{sub}−1)]^{T}, a relationship between X_{m,l} and y_{mL}_{_{sub}}₊ₗ=[y_{mL}_{_{sub}}₊ₗ(0), y_{mL}_{_{sub}}₊ₗ(1), . . . , y_{mL}_{_{sub}}₊ₗ(N_{sub}−1)]^{T} may be represented as the following Formula (7):

$${y}_{{mL}_{sub} + l} ( κ ) = {e}^{j 2 π \frac{κ {f}_{d}}{N Δ f}} {e}^{j 2 π {f}_{d} [ {mT}_{s} + ( l - 1 ) {T}_{sub} + {T}_{CP} ]} {\sum }_{q = 0}^{{N}_{sub} - 1} {X}_{m , l} ( q ) {e}^{j 2 π q \frac{κ}{{N}_{sub}}} {e}^{- j 2 π {qL}_{sub} Δ f τ} \approx {e}^{j 2 π {f}_{d} [ {mT}_{s} + ( l - 1 ) {T}_{sub} + {T}_{CP} ]} {\sum }_{q = 0}^{{N}_{sub} - 1} {X}_{m , l} ( q ) {e}^{j 2 π q \frac{κ}{{N}_{sub}}} {e}^{- j 2 π {qL}_{sub} Δ f τ} , where \qquad ( 7 )$$

$${T}_{s} = {T}_{CP} + \frac{1}{Δ f}$$

represents duration of a symbol including the CP, T_{CP} represents duration of the CP,

$${T}_{sub} = \frac{1}{( Δ f ) {L}_{sub}}$$

represents duration of a subsymbol, Δf represents a subcarrier spacing, f_{d} represents a Doppler frequency, and τ represents a delay. An exponential term

$${e}^{j 2 π \frac{κ {f}_{d}}{N Δ f}}$$

represents a Doppler effect in a pulse. Because f_{d} is generally much smaller than signal bandwidth NΔf, f_{d} is approximately equal to 1 when κ∈{0, 1, . . . , N_{sub}−1}. Approximate processing of the Doppler effect in the pulse leads to inter-subcarrier interference, which deteriorates delay estimation performance.

In a conventional solution, an echo signal is divided at a granularity of a length of a symbol not a subsymbol, and a Doppler effect in a pulse is

$${e}^{j 2 π \frac{{κ}_{1} {f}_{d}}{N Δ f}} ,$$

κ₁∈{0, 1, . . . , N−1}. Similarly, in the conventional solution,

$${e}^{j 2 π \frac{{κ}_{1} {f}_{d}}{N Δ f}}$$

is also approximated as 1. It can be learned through comparison that, in embodiments of the present disclosure, the Doppler effect in the pulse is ignored in an observation window whose length is N_{sub}, and in the conventional solution, the Doppler effect in the pulse is ignored in an observation window whose length is N. Therefore, in embodiments of the present disclosure, delay estimation performance can be improved.

In addition, in embodiments of the present disclosure, Doppler DFT is performed along a subsymbol, and a maximum unambiguous Doppler frequency is a reciprocal of duration of the subsymbol. In the conventional solution, Doppler DFT is performed along an OFDM symbol, and the maximum unambiguous Doppler frequency is a reciprocal of duration of the symbol. The duration of the subsymbol is 1/L_{sub} of the duration of the entire OFDM symbol. Therefore, in embodiments of the present disclosure, the maximum unambiguous Doppler frequency can be maximally increased by L_{sub} times, where L_{sub} is a quantity of subsymbols.

From a communication perspective, in embodiments of the present disclosure, demodulation and detection performance at a high Doppler frequency can be improved. For example, because a sampling rate of the subsymbol is the same as a sampling rate of the OFDM symbol, a communication receiver may first perform N_{sub}-point DFT on the subsymbol, and then perform symbol demodulation in frequency domain. A frequency-domain signal generated by performing the N_{sub}-point DFT on the subsymbol may correspond to a subcarrier spacing L_{sub} Δf. Because a large subcarrier spacing helps improve demodulation performance of a receiver in a high Doppler scenario, in embodiments of the present disclosure, demodulation performance in the high Doppler scenario can be improved.

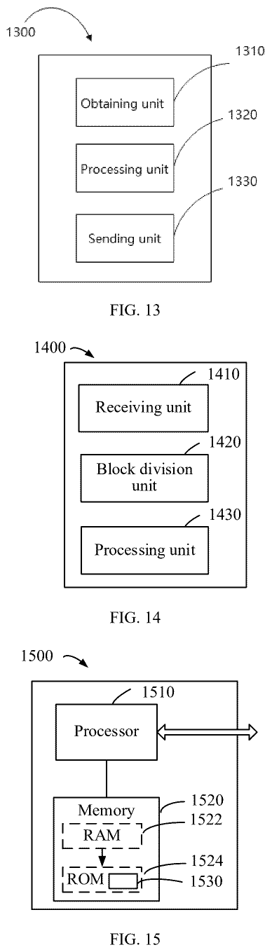

Corresponding to the foregoing sending and receiving methods, embodiments of the present disclosure further provide a communication apparatus and a device. The following provides descriptions thereof with reference to FIG. 13 and FIG. 14. FIG. 13 is a block diagram of a communication apparatus 1300 according to an embodiment of the present disclosure. The apparatus 1300 may be implemented at a transmit device (for example, the communication device 110 in FIG. 1). For convenience, the following describes FIG. 13 with reference to the example in FIG. 1. The apparatus 1300 may be a part of the transmit device, or may be the transmit device. It should be understood that the apparatus 1300 may include more additional components than the shown components or omit a part of the shown components. This is not limited in this embodiment of the present disclosure.

As shown in FIG. 13, the apparatus 1300 may include an obtaining unit 1310, a processing unit 1320, and a sending unit 1330. The obtaining unit 1310 is configured to obtain a set of data streams, where a first data stream in the set includes a set of data segments, and each data segment in the set of data segments includes a data sequence and at least one predetermined sequence. The processing unit 1320 is configured to process the set of data streams to obtain a time-domain signal including a cyclic prefix and a plurality of subsymbols, where tail signals of the plurality of subsymbols are the same, and the tail signal is associated with the at least one predetermined sequence. The sending unit 1330 is configured to send the time-domain signal.

In some embodiments, lengths of the plurality of subsymbols may be the same, and may be determined based on a quantity that is of sampling points and that corresponds to the time-domain signal and a quantity of the plurality of subsymbols.

In some embodiments, the quantity of the plurality of subsymbols may be associated with at least one of the following: a subcarrier mapping spacing associated with subcarrier mapping included in the processing; a quantity of data segments; or a quantity that is of sampling points and that corresponds to the time-domain signal.

In some embodiments, a length of the data segment is determined based on at least one of the following: a quantity that is of subcarriers and that corresponds to bandwidth allocated for the processing; a quantity of the plurality of subsymbols; or a subcarrier mapping spacing associated with subcarrier mapping included in the processing.

In some embodiments, the set may include a plurality of data streams, the plurality of data streams include the first data stream and a second data stream, and a periodic time-domain signal is obtained by performing the processing on the second data stream. In some embodiments, a periodicity of the periodic time-domain signal may be related to a length of each of the plurality of subsymbols.

In some embodiments, a quantity of second data streams may be associated with at least one of the following: a subcarrier mapping spacing associated with the subcarrier mapping included in the processing; or a quantity that is of sampling points and that corresponds to the time-domain signal.

In some embodiments, the set of data streams may include one data stream, and the data stream is the first data stream.

In some embodiments, the at least one predetermined sequence may include at least one of the following: a head sequence, where the head sequence is before the data sequence; or a tail sequence, where the tail sequence is after the data sequence. In some embodiments, the at least one predetermined sequence may include the head sequence and the tail sequence. A first quantity of front-part sampling points of each of the subsymbols is associated with the head sequence, and a second quantity of rear-part sampling points is associated with both the head sequence and the tail sequence.

In some embodiments, the first quantity is determined based on at least one of a length of the head sequence, a quantity that is of subcarriers and that corresponds to bandwidth allocated for the processing, and a quantity that is of sampling points and that corresponds to the time-domain signal; and the second quantity is determined based on at least one of a length of the tail sequence, the quantity that is of subcarriers and that corresponds to the bandwidth allocated for the processing, and the quantity that is of sampling points and that corresponds to the time-domain signal.

In some embodiments, the length of the head sequence may be associated with at least one of the following: a quantity that is of subcarriers and that corresponds to bandwidth allocated for the processing; a quantity that is of sampling points and that corresponds to the time-domain signal; a quantity of the plurality of subsymbols; and an expected mean square error level for a difference between the tail signals of the subsymbols.

In some embodiments, the length of the tail sequence may be associated with at least one of the following: a length of a cyclic prefix added to the time-domain signal; a quantity that is of subcarriers and that corresponds to bandwidth allocated for the processing; a quantity that is of sampling points and that corresponds to the time-domain signal; a quantity of the plurality of subsymbols; and an expected mean square error level for a difference between the tail signals of the subsymbols.

In some embodiments, the processing unit 1320 may include: a precoding unit, configured to precode the set of data streams to obtain a set of frequency-domain streams; a subcarrier mapping unit, configured to separately perform subcarrier mapping on a frequency-domain stream in the set of frequency-domain streams, to obtain a frequency-domain signal; and a transform unit, configured to perform frequency-domain to time-domain transform on the frequency-domain signal to obtain the time-domain signal.

In some embodiments, the precoding unit may include at least one of the following: a first determining unit, configured to determine, based on an index of one data stream in the set of data streams, a method for precoding the data stream; and a second determining unit, configured to determine, based on indexes of a plurality of data streams in the set of data streams, a method for precoding the plurality of data streams.

In some embodiments, the subcarrier mapping unit may include: a determining unit, configured to determine, based on at least one of an index of the frequency-domain stream, a signal length corresponding to the frequency-domain stream, a subcarrier mapping spacing associated with the subcarrier mapping, or a quantity that is of subcarriers and that corresponds to bandwidth allocated for the processing, a subcarrier index corresponding to the frequency-domain stream.

In some embodiments, the subcarrier mapping spacing may be associated with at least one of the following: a quantity of data streams in the set of data streams; a quantity of a plurality of subsymbols; or a quantity that is of sampling points and that corresponds to a time-domain signal.

In some embodiments, the sending unit 1330 may include: an adding unit, configured to add a cyclic prefix to the time-domain signal; and a signal sending unit, configured to send the time-domain signal to which the cyclic prefix is added.

For other details of the apparatus 1300, refer to the descriptions in the sending method 300. Details are not described herein.

FIG. 14 is a block diagram of a communication apparatus 1400 according to an embodiment of the present disclosure. The apparatus 1400 may be implemented at a receiving device (for example, the communication device 110 in FIG. 1). For convenience, the following describes FIG. 14 with reference to the example in FIG. 1. The apparatus 1400 may be a part of the receiving device, or may be the receiving device. It should be understood that the apparatus 1400 may include more additional components than the shown components or omit a part of the shown components. This is not limited in this embodiment of the present disclosure.

As shown in FIG. 14, the apparatus 1400 may include a receiving unit 1410, a block division unit 1420, and a processing unit 1430. The receiving unit 1410 is configured to receive a signal, where the signal includes a cyclic prefix and a plurality of subsymbols. The block division unit 1420 is configured to divide the signal into a plurality of blocks based on a length of the cyclic prefix and lengths of the plurality of subsymbols, to cause an overlap of the length of the cyclic prefix to exist between two adjacent blocks in the plurality of blocks. The processing unit 1430 is configured to perform processing based on the plurality of blocks.

In some embodiments, the processing unit 1430 may include: a removing unit, configured to remove a third quantity of front-part sampling values of each of the plurality of blocks, to obtain a plurality of processed blocks, where the third quantity corresponds to the length of the cyclic prefix; and an execution unit, configured to perform the processing based on the plurality of processed blocks.

In some embodiments, the signal is an echo signal from a target, and the processing is sensing processing. In some embodiments, the signal is a signal received through a communication channel, and the processing is communication information demodulation processing.

For other details of the apparatus 1400, refer to the descriptions in the receiving method 1100. Details are not described herein.

FIG. 15 is a simplified block diagram of a communication device 1500 suitable for implementing embodiments of the present disclosure. The device 1500 may be provided to implement a transmit device or a receiving device or a communication device that includes a transmitting function and a receiving function. As shown, the device 1500 includes one or more processors 1510 and one or more memories 1520 coupled to the processor 1510.

The processor 1510 may be any type suitable for a native technology network, and as a limiting example, may include one or more of the following: a general-purpose computer, a dedicated computer, a microprocessor, a digital signal processor, and a processor that is based on a multi-core processor architecture. The device 1500 may have a plurality of processors, such as application-specific integrated circuit chips, which in time belong to a clock synchronized with a main processor.

The memory 1520 may include one or more non-volatile memories and one or more volatile memories. An example of the non-volatile memory includes but is not limited to a read-only memory (ROM) 1524, an electrically programmable read-only memory (EPROM), a flash memory, a hard disk drive, a compact disc (CD), a digital video disk (DVD), and another magnetic storage and/or optical storage apparatus. An example of the volatile memory includes but is not limited to a random access memory (RAM) 1522 and another volatile memory that does not persist during power-off duration.

A computer program 1530 includes computer-executable instructions executed by an associated processor 1510. The program 1530 may be stored in the ROM 1524. The processor 1510 may perform any appropriate action and processing by loading the program 1530 into the RAM 1522.

Embodiments of the present disclosure may be implemented by using the program 1530, so that the device 1500 performs the processing in the present disclosure as discussed with reference to FIG. 3 to FIG. 12. The device 1500 may correspond to any one of the foregoing communication apparatuses 1300 and 1400, and function modules in each of the communication apparatuses 1300 and 1400 is implemented by using software of the device 1500. In other words, the function modules included in each of the communication apparatuses 1300 and 1400 are generated after the processor 1510 of the device 1500 reads program code stored in the memory 1520. Embodiments of the present disclosure may alternatively be implemented by using hardware or a combination of software and hardware.

In some embodiments, the program 1530 may be tangibly included in a computer-readable medium, and the computer-readable medium may be included in the device 1500 (for example, in the memory 1520) or another storage device that may be accessed by the device 1500. The program 1530 may be loaded from the computer-readable medium into the RAM 1522 for execution. The computer-readable medium may include any type of tangible non-volatile memory, for example, a ROM, an EPROM, a flash memory, a hard disk drive, a CD, or a DVD.

In some embodiments, the device 1500 may further include one or more communication modules (not shown). The one or more communication modules may be coupled to the processor 1510. The one or more communication modules may be configured for bidirectional communication. The one or more communication modules may have a communication interface to facilitate communication. The communication interface may represent any interface necessary to communicate with another network element.

In general, the various example embodiments of the present disclosure may be implemented in hardware or dedicated circuits, software, logic, or any combination thereof. Some aspects may be implemented in hardware, while other aspects may be implemented in firmware or software that may be executed by a controller, a microprocessor, or another computing device. When various aspects of embodiments of the present disclosure are illustrated or described as block diagrams, flowcharts, or using some other graphical representation, it is appreciated that the blocks, apparatuses, systems, technologies, or methods described herein may be implemented as non-restrictive examples in hardware, software, firmware, dedicated circuits or logic, general-purpose hardware or controllers, or other computing devices, or some combination thereof. An example of a hardware device that may be used to implement embodiments of the present disclosure includes but is not limited to a field programmable gate array (FPGA), an application specific integrated circuit (ASIC), an application-specific standard part (ASSP), a system on chip (SOC), a complex programmable logic device (CPLD), and the like.

In an example, embodiments of the present disclosure may be described in the context of machine-executable instructions. For example, the machine-executable instructions are included in a program module executed in a device on a target real or virtual processor. Usually, the program module includes a routine, a program, a library, an object, a class, a component, a data structure, and the like, and executes a specific task or implements a specific abstract data structure. In various embodiments, the functions of the program modules may be combined or split between the described program modules. The machine-executable instructions used for the program module may be executed locally or in a distributed device. In the distributed device, the program module may be located in both a local storage medium and a remote storage medium.

Computer program code for implementing the method disclosed in the present disclosure may be written in one or more programming languages. The computer program code may be provided for a processor of a general-purpose computer, a dedicated computer, or another programmable data processing apparatus, so that when the program code is executed by the computer or the another programmable data processing apparatus, functions/operations specified in the flowcharts and/or block diagrams are implemented. The program code may be executed entirely on a computer, partly on a computer, as an independent software package, partly on a computer and partly on a remote computer, or entirely on a remote computer or a server.

In the context of the present disclosure, the computer program code or related data may be carried in any appropriate carrier, so that the device, the apparatus, or the processor can perform various processing and operations described above. An example of the carrier includes a signal, a computer-readable medium, and the like.

An example of the signal may include an electrical signal, an optical signal, a radio signal, a voice signal, or other forms of propagated signals, such as a carrier wave and an infrared signal.

The machine-readable medium may be any tangible medium that includes or stores programs for or with respect to an instruction execution system, apparatus, or device. The machine-readable medium may be a machine-readable signal medium or a machine-readable storage medium. The machine-readable medium may include but is not limited to an electronic, magnetic, optical, electromagnetic, infrared, or semiconductor system, apparatus, or device, or any appropriate combination thereof. A more detailed example of the machine-readable storage medium includes an electrical connection with one or more wires, a portable computer disk, a hard disk drive, a RAM, a ROM, an EPROM or flash memory, an optical storage device, a magnetic storage device, or any appropriate combination thereof.

In addition, although the operations are described in a particular order, this should not be understood as requiring the operations to be completed in the particular order shown or in a sequential order, or performing all of the illustrated operations to obtain a desired result. In some cases, multitasking or parallel processing is beneficial. Likewise, although the discussion above includes some specific implementation details, this should not be construed as a limitation on the scope of any disclosure or claim, but rather as a description of a specific embodiment that may be directed to a particular disclosure. Some features described in the context of separate embodiments in this specification may also be incorporated and implemented in a single embodiment. Conversely, various features described in the context of a single embodiment may also be implemented separately in a plurality of embodiments or in any appropriate sub-combination.

Although the subject matter has been described in language specific to structural features and/or methodological actions, it should be understood that the subject matter defined in the appended claims is not limited to the specific features or actions described above. Rather, the specific features and actions described above are disclosed as example forms of implementing the claims.

1. A communication method, comprising:
obtaining a set of data streams, wherein a first data stream in the set of data streams comprises a set of data segments that each comprise a data sequence and at least one predetermined sequence;
processing the set of data streams to obtain a time-domain signal that comprises a plurality of subsymbols, wherein tail signals of the plurality of subsymbols are the same, and the tail signal is associated with the at least one predetermined sequence; and
sending the time-domain signal.

2. The method according to claim 1, wherein lengths of the plurality of subsymbols are the same, and are determined based on a quantity that is of sampling points and that corresponds to the time-domain signal and a quantity of the plurality of subsymbols.

3. The method according to claim 1, wherein a quantity of the plurality of subsymbols is associated with at least one of the following:
a subcarrier mapping spacing associated with subcarrier mapping comprised in the processing;
a quantity of data segments; or
a quantity that is of sampling points and that corresponds to the time-domain signal.

4. The method according to claim 1, wherein a length of each data segment is determined based on at least one of the following:
a quantity that is of subcarriers and that corresponds to bandwidth allocated for the processing;
a quantity of the plurality of subsymbols; or
a subcarrier mapping spacing associated with subcarrier mapping comprised in the processing.

5. The method according to claim 1, wherein the set of data streams comprises the first data stream and one or more second data streams, and a periodic time-domain signal is obtained by performing the processing on the one or more second data streams

6. The method according to claim 5, wherein a quantity of the one or more second data streams is associated with at least one of the following:
a subcarrier mapping spacing associated with subcarrier mapping comprised in the processing; or
a quantity that is of sampling points and that corresponds to the time-domain signal.

7. The method according to claim 5, wherein a periodicity of the periodic time-domain signal is related to a length of each of the plurality of subsymbols.

8. The method according to claim 1, wherein the set of data streams consists of the first data stream, the first data stream is a single data steam.

9. The method according to claim 1, wherein the at least one predetermined sequence comprises at least one of the following:
a head sequence before the data sequence; or
a tail sequence after the data sequence.

10. The method according to claim 9, wherein a first quantity of front-part sampling points of each of the subsymbols is associated with the head sequence, and a second quantity of rear-part sampling points is associated with both the head sequence and the tail sequence.

11. The method according to claim 10, wherein the first quantity is determined based on at least one of a length of the head sequence, a quantity that is of subcarriers and that corresponds to bandwidth allocated by a system, or a quantity that is of sampling points and that corresponds to the time-domain signal, and
the second quantity is determined based on at least one of the length of the tail sequence, a quantity that is of subcarriers and that corresponds to bandwidth allocated for the processing, or the quantity that is of the sampling points and that corresponds to the time-domain signal.

12. The method according to claim 9, wherein a length of the head sequence is associated with at least one of the following:
a quantity that is of subcarriers and that corresponds to bandwidth allocated for the processing;
a quantity that is of sampling points and that corresponds to the time-domain signal;
a quantity of the plurality of subsymbols; or
an expected mean square error level for a difference between the tail signals of the subsymbols.

13. The method according to claim 9, wherein a length of the tail sequence is associated with at least one of the following:
a length of a cyclic prefix added to the time-domain signal;
a quantity that is of subcarriers and that corresponds to bandwidth allocated for the processing;
a quantity that is of sampling points and that corresponds to the time-domain signal;
a quantity of the plurality of subsymbols; or
an expected mean square error level for a difference between the tail signals of the subsymbols.

14. The method according to claim 1, wherein processing the set of data streams comprises:
precoding the set of data streams to obtain a set of frequency-domain streams;
separately performing subcarrier mapping on a frequency-domain stream in the set of frequency-domain streams, to obtain a frequency-domain signal; and
performing frequency-domain to time-domain transform on the frequency-domain signal to obtain the time-domain signal.

15. The method according to claim 14, wherein the precoding the set of data streams comprises:
determining, based on an index of one data stream in the set of data streams, a method for precoding the data stream; or
determining, based on indexes of a plurality of data streams in the set of data streams, a method for precoding the plurality of data streams.

16. The method according to claim 14, wherein separately performing the subcarrier mapping on the frequency-domain stream comprises:
determining, based on at least one of the following, a subcarrier index corresponding to the frequency-domain stream:
an index of the frequency-domain stream;
a signal length corresponding to the frequency-domain stream;
a subcarrier mapping spacing associated with the subcarrier mapping; or
a quantity that is of subcarriers and that corresponds to bandwidth allocated for the processing.

17. The method according to claim 14, wherein a subcarrier mapping spacing associated with the subcarrier mapping is associated with at least one of the following:
a quantity of data streams in the set of data streams;
a quantity of the plurality of subsymbols;
a quantity that is of sampling points and that corresponds to the time-domain signal; or
a quantity of data segments.

18. A communication method, comprising:
receiving a signal that comprises a cyclic prefix and a plurality of subsymbols;
dividing the signal into a plurality of blocks based on a length of the cyclic prefix and lengths of the plurality of subsymbols, such that an overlap of the length of the cyclic prefix exists between two adjacent blocks in the plurality of blocks; and
performing processing based on the plurality of blocks.

19. The method according to claim 18, wherein the performing the processing comprises:
removing a third quantity of front-part sampling values of each of the plurality of blocks, to obtain a plurality of processed blocks, wherein the third quantity corresponds to the length of the cyclic prefix; and
performing the processing based on the plurality of processed blocks.

20. A communication device, comprising:
a processor, and
a memory, comprising a computer program code for execution by the processor, the computer program code comprising instructions for:
obtaining a set of data streams, wherein a first data stream in the set of data streams comprises a set of data segments that each comprise a data sequence and at least one predetermined sequence;
processing the set of data streams to obtain a time-domain signal that comprises a plurality of subsymbols, wherein tail signals of the plurality of subsymbols are the same, and the tail signal is associated with the at least one predetermined sequence; and
sending the time-domain signal.
